(19) United States
(12) Patent Application Publication
(10) Pub. No.: US 2018/0257413 A1
(43) Pub. Date: Sep. 13, 2018

(54) IMAGE FORMING APPARATUS, NOTIFICATION METHOD, COMPUTER PROGRAM, AND STORAGE MEDIUM

(71) Applicant: CANON KABUSHIKI KAISHA, Tokyo (JP)

(72) Inventor: Takeshi Aoyagi, Tokyo (JP)

(21) Appl. No.: 15/756,963

(22) PCT Filed: Aug. 26, 2016
(86) PCT No.: PCT/JP2016/003897

§ 371 Date: Mar. 1, 2018

(30) Foreign Application Priority Data
Sep. 2, 2015 (JP) 2015-173231

(51) Int. Cl. B41J 29/393; H04N 1/00; B41J 29/46

(52) U.S. Cl. CPC B41J 29/393; B41J 29/46; H04N 1/00108

(57) ABSTRACT

Provided is an image forming apparatus that perform notification of disaster prevention information in an appropriate notification mode. An MFP (100) functioning as the image forming apparatus includes a radio reception unit (202) configured to receive the disaster prevention information including information indicating an importance level of a content from a transmitting station (600), a printing unit (205) configured to perform image formation on a predetermined sheet, and a UI unit (206) configured to perform notification of the disaster prevention information. The MFP (100) recognizes the importance level of the disaster prevention information received by the radio reception unit (202) and causes the UI unit (206) to perform the notification of the disaster prevention information in a notification mode in accordance with the recognized importance level. The MFP (100) also causes the printing unit (205) to print and output a predetermined image in accordance with the recognized importance level.

### TECHNICAL FIELD

The present invention relates to an image forming apparatus such as a multi-function peripheral having a function of receiving disaster prevention radio.

### BACKGROUND ART

A disaster prevention radio system using a digital broadcast radio system has been proposed. In the digital broadcast radio system, disaster prevention information is distributed using radio waves at 280 [MHz] by transmitters arranged at various locations. A resident owns a disaster prevention radio set having a channel dedicated to the disaster prevention radio set 280 [MHz]. While the disaster prevention radio set receives the disaster prevention information, the resident is notified of a content of the received disaster prevention information by way of audio or light flashing.

A disaster prevention radio receiver such as the disaster prevention radio set is designed to be arranged and used in an individual house. However, many people work in an office in daytime, and a receiver that notifies people in the office of the disaster prevention information is needed. In addition, the digital broadcast radio system is appropriate for the notification of the disaster prevention information in a building such as the office since the radio wave at 280 [MHz] is used in the digital broadcast radio system.

Use of a highly functional image forming apparatus (hereinafter, will be referred to as a multi-function peripheral (MFP)) as the disaster prevention radio receiver is under review. This is because an adoption rate of the MFP to the office is high. In addition, the MFP includes a notification unit such as a speaker configured to notify people of the disaster prevention information by way of sound, a light emitting unit configured to flash light, or a display unit configured to display the disaster prevention information by way of characters as a user interface as standard equipment. For this reason, as compared with a case where a dedicated receiver is introduced, the MFP is preferably used as the disaster prevention radio receiver in terms of an introduction cost and an installment location. When a disaster occurs, it is expected that it becomes difficult to perform information collection by using a personal computer or a mobile terminal because of power cut, access concentration to a base station from mobile terminals, or the like. In the above-described case, a user can secure useful information while the MFP prints out a map illustrating a surrounding district or an evacuation route, a staff register in the office, a location confirmation list, or the like on paper in addition to the notification of the disaster prevention information. PTL 1 describes an invention of the above-described MFP. This MFP activates in case of emergency, collects information from a network, and optimizes a printout layout of the information or the like to be output. In this manner, it is extremely useful to mount a reception function of the digital broadcast radio system to the MFP.

In the disaster prevention radio, pieces of disaster prevention information having various urgency levels and importance levels such as regular notice, advisory, warning, information on a large-scale earthquake or tidal wave are distributed. A notification mode to the user needs to be changed in accordance with the urgency level and the importance level. For example, it is sufficient even when notification of notice level information to the user is not actively performed, and notification of the information on the large-scale earthquake or tidal wave to many users needs to be performed while a volume of the speaker is maximized. In addition, in a case where the evacuation information is to be printed, an evacuation route at the time of the earthquake or tidal wave, an evacuation route at the time of flood or landslides, or the like needs to be appropriately output in accordance with a type of the notified disaster or a place of the occurrence of the disaster. In this manner, it is important for the disaster prevention radio receiver to appropriately notify the user in accordance with a content of the disaster prevention information.

To address the above-described issues, the present invention is mainly aimed at providing an image forming apparatus that performs notification of the disaster prevention information obtained by the disaster prevention radio in an appropriate notification mode.

### CITATION LIST

### Patent Literature

PTL 1: Japanese Patent Laid-Open No. 2015-22739

### SUMMARY OF INVENTION

### Solution to Problem

An image forming apparatus according to an aspect of the present invention includes a reception unit configured to receive disaster prevention information including information indicating an importance level of a content, a printing unit configured to print and output an image on a predetermined sheet, a notification unit configured to perform notification of the disaster prevention information, and a control unit configured to recognize the importance level of the disaster prevention information and cause the notification unit to perform the notification of the disaster prevention information in a notification mode in accordance with the recognized importance level and the printing unit to print and output a predetermined image in accordance with the importance level.

Further features of the present invention will become apparent from the following description of exemplary embodiments with reference to the attached drawings.

### BRIEF DESCRIPTION OF DRAWINGS

FIG. 1A is an explanatory diagram for describing a disaster prevention radio system.

FIG. 1B is an explanatory diagram for describing the disaster prevention radio system.

FIG. 2A is an explanatory diagram for describing reception data.

FIG. 2B is an explanatory diagram for describing the reception data.

FIG. 3A is a configuration illustrative diagram of a UI unit and a controller unit.

FIG. 3B is a configuration illustrative diagram of the UI unit and the controller unit.

FIG. 4A is an explanatory diagram for describing a UI control signal and correspondence setting information.

FIG. 4B is an explanatory diagram for describing the UI control signal and the correspondence setting information.

FIG. 4C is an explanatory diagram for describing the UI control signal and the correspondence setting information.

FIG. 5A is an illustrative diagram of a setting screen of the correspondence setting information.

FIG. 5B is an illustrative diagram of the setting screen of the correspondence setting information.

FIG. 5C is an illustrative diagram of the setting screen of the correspondence setting information.

FIG. 6A is an illustrative diagram of the setting screen of the correspondence setting information.

FIG. 6B is an illustrative diagram of the setting screen of the correspondence setting information.

FIG. 6C is an illustrative diagram of the setting screen of the correspondence setting information.

FIG. 6D is an illustrative diagram of the setting screen of the correspondence setting information.

FIG. 6E is an illustrative diagram of the setting screen of the correspondence setting information.

FIG. 6F is an illustrative diagram of the setting screen of the correspondence setting information.

FIG. 6G is an illustrative diagram of the setting screen of the correspondence setting information.

FIG. 6H is an illustrative diagram of the setting screen of the correspondence setting information.

FIG. 6I is an illustrative diagram of the setting screen of the correspondence setting information.

FIG. 7A is an illustrative diagram of the setting screen of the correspondence setting information.

FIG. 7B is an illustrative diagram of the setting screen of the correspondence setting information.

FIG. 7C is an illustrative diagram of the setting screen of the correspondence setting information.

FIG. 8A is a flow chart representing setting processing of the correspondence setting information.

FIG. 8B is a flow chart representing the setting processing of the correspondence setting information.

FIG. 9 is a flow chart representing notification processing of disaster prevention information.

FIG. 10 is an illustrative diagram of an image to be printed and output.

FIG. 11A is an explanatory diagram for describing the controller unit.

FIG. 11B is an explanatory diagram for describing the controller unit.

FIG. 12A is an explanatory diagram for describing keyword information.

FIG. 12B is an explanatory diagram for describing the keyword information.

FIG. 12C is an explanatory diagram for describing the keyword information.

FIG. 13A is an illustrative diagram of a setting screen of keyword setting information.

FIG. 13B is an illustrative diagram of the setting screen of the keyword setting information.

FIG. 13C is an illustrative diagram of the setting screen of the keyword setting information.

FIG. 14 is a flow chart representing setting processing of the keyword setting information and the correspondence setting information.

FIG. 15 is an illustrative diagram of the keyword setting information and the correspondence setting information.

FIG. 16 is a flow chart representing the notification processing of the disaster prevention information.

FIG. 17A is an explanatory diagram for describing the correspondence setting information.

FIG. 17B is an explanatory diagram for describing the correspondence setting information.

FIG. 17C is an explanatory diagram for describing the correspondence setting information.

FIG. 18 is a flow chart representing the setting processing of the correspondence setting information.

FIG. 19 is a schematic diagram of the UI unit.

FIG. 20A is an explanatory diagram for describing the UI control signal and the correspondence setting information.

FIG. 20B is an explanatory diagram for describing the UI control signal and the correspondence setting information.

FIG. 20C is an explanatory diagram for describing the UI control signal and the correspondence setting information.

FIG. 21A is an illustrative diagram of the setting screen of the correspondence setting information.

FIG. 21B is an illustrative diagram of the setting screen of the correspondence setting information.

FIG. 21C is an illustrative diagram of the setting screen of the correspondence setting information.

FIG. 22A is an illustrative diagram of the setting screen of the correspondence setting information.

FIG. 22B is an illustrative diagram of the setting screen of the correspondence setting information.

FIG. 23 is a flow chart representing the setting processing of the correspondence setting information.

FIG. 24 is a flow chart representing the notification processing of the disaster prevention information.

FIG. 25A is an illustrative diagram of a screen for inputting a notification stop instruction.

FIG. 25B is an illustrative diagram of the screen for inputting the notification stop instruction.

### DESCRIPTION OF EMBODIMENTS

Hereinafter, embodiments of the present invention will be described in detail with reference to the accompanying drawings. It should be noted that the following embodiments are not limited to the present invention as described in the section of claims, and also, all of combinations of features described in the present embodiment are not necessarily essential to solving means of the present invention.

### First Embodiment

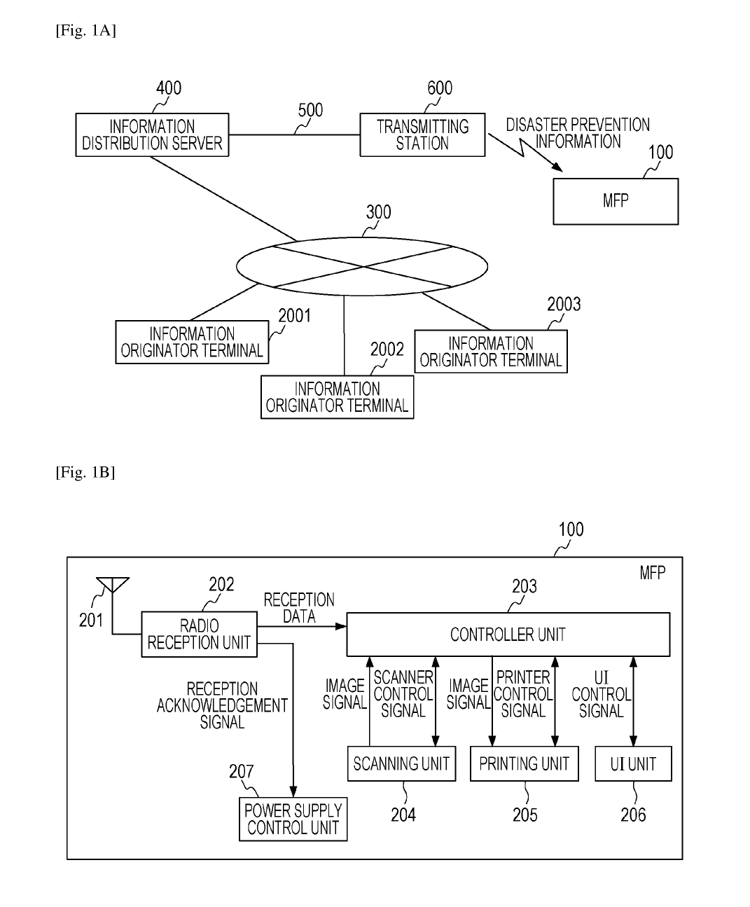

FIGS. 1A and 1B are explanatory diagrams for describing a disaster prevention radio system including an image forming apparatus according to the present embodiment. FIG. 1A is a schematic diagram of the disaster prevention radio system. This disaster prevention radio system uses a digital broadcast radio system and is provided with a plurality of information originator terminals 2001 to 2003, an information distribution server 400, a transmitting station 600, and an MFP 100 functioning as a highly functional image forming apparatus. The information originator terminals 2001 to 2003 and the information distribution server 400 are connected to each other so as to be mutually communicable via a public communication line 300 such as the internet. The information distribution server 400 and the transmitting station 600 are connected to each other so as to be mutually communicable by a dedicated line 500 using an optical line, a satellite channel, or the like.

The information originator terminals 2001 to 2003 are terminals functioning as originating sources of disaster prevention information or the like in the disaster prevention radio system. Although only the three information originator terminals 2001 to 2003 are illustrated in FIG. 1A, a large number of information originator terminals are provided in actuality. The respective information originator terminals 2001 to 2003 transmit information such as the disaster prevention information to the information distribution server 400 via the public communication line 300. The information distribution server 400 transmits the information such as the disaster prevention information received from the respective information originator terminals 2001 to 2003 via the public communication line 300 to the transmitting station 600 via the dedicated line 500. The transmitting station 600 distributes the information such as the disaster prevention information received from the information distribution server 400 via the dedicated line 500 to the MFP 100 by a radio communication using radio waves at 280 [MHz], for example.

Although only one MFP 100 is illustrated in FIG. 1A, a large number of MFPs 100 are provided in actuality. The respective MFPs 100 receive the disaster prevention information distributed from the transmitting station 600. The MFP 100 notifies a user of the received disaster prevention information. FIG. 1B is a schematic diagram of the MFP 100. The MFP 100 includes an antenna 201, a radio reception unit 202, a controller unit 203, a scanning unit 204, a printing unit 205, a user interface (UI) unit 206, and a power supply control unit 207.

The antenna 201 receives the radio waves of the radio communication transmitted from the transmitting station 600 and inputs the radio waves to the radio reception unit 202. The radio reception unit 202 receives the disaster prevention information distributed from the transmitting station 600 by way of the radio waves input from the antenna 201. The radio reception unit 202 generates reception data corresponding to digital data on the basis of the radio waves input from the antenna 201. The reception data is input to the controller unit 203. In addition, the radio reception unit 202 generates a reception acknowledgement signal representing that the radio waves have been received from the transmitting station 600 and inputs the reception acknowledgement signal to the power supply control unit 207.

The power supply control unit 207 controls power supply to the respective units in the MFP 100 such as the controller unit 203, the scanning unit 204, the printing unit 205, and the UI unit 206. For example, when the reception acknowledgement signal is input in a state in which the power supply to the respective units in the MFP 100 is saved as in a sleep mode, the power supply control unit 207 resumes the power supply to the respective units while this input is regarded as a trigger.

The controller unit 203 controls operations of the scanning unit 204, the printing unit 205, and the UI unit 206. The controller unit 203 is constituted, for example, by a central processing unit (CPU). As an alternative configuration to the above, the controller unit 203 may be constituted by an application specific integrated circuit (ASIC), a field-programmable gate array (FPGA), or the like. The controller unit 203 realizes a function and processing related to the notification of the disaster prevention information while the CPU reads and executes a computer program, for example.

The scanning unit 204 is an image reading unit. The scanning unit 204 optically reads an original image from an original and generates an image signal corresponding to a digital signal representing the read original image. The scanning unit 204 inputs the generated image signal to the controller unit 203. An operation of the scanning unit 204 is controlled by a scanner control signal input from the controller unit 203.

The printing unit 205 is an image forming unit and forms an image on a sheet using ink, toner, or the like on the basis of the image signal input from the controller unit 203 and outputs the image. An operation of the printing unit 205 is controlled by a printer control signal input from the controller unit 203.

The UI unit 206 is an interface with the user and is provided with an input unit and an output unit. The input unit includes a button, a switch, a numerical keypad, or the like used by the user to perform various settings with respect to the MFP 100. The output unit includes a display unit configured to display a state of the MFP 100 or a setting screen, a light emitting unit such as a light emitting diode (LED), a speaker, or the like. It should be noted that the display unit constitutes a touch panel functioning as an input and output apparatus in which a transparent touch pad is formed on a display surface. An operation of the UI unit 206 is controlled by a UI control signal input from the controller unit 203.

In a case where the MFP 100 having the above-described configuration performs a copy operation, the controller unit 203 performs settings of various image processings on the basis of an input by the UI unit 206. After the settings are completed, the controller unit 203 controls the scanning unit 204 to obtain the image signal representing the original image. The controller unit 203 performs the image processings in accordance with the settings to generate an image signal for image formation. The controller unit 203 inputs the generated image signal for the image formation and the printer control signal to the printing unit 205. The printing unit 205 performs image forming processing on the basis of the input image signal and outputs the sheet on which the image is formed.

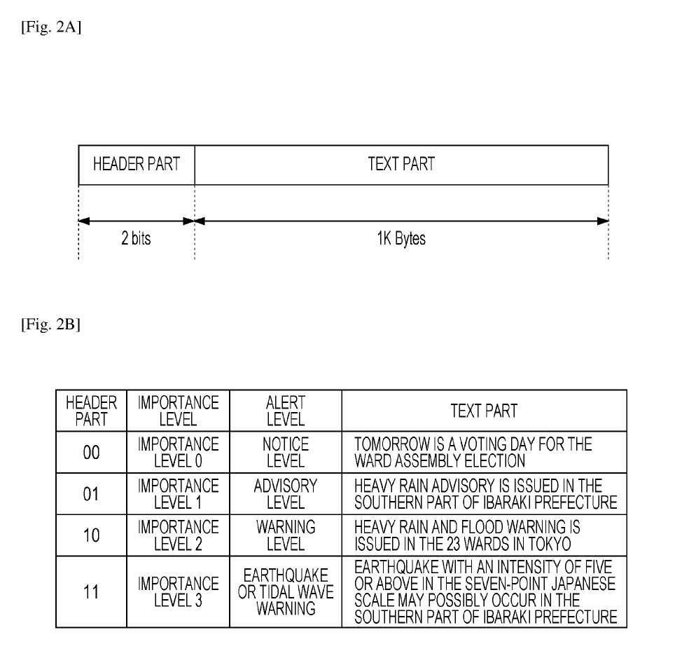

FIGS. 2A and 2B are explanatory diagrams for describing the reception data generated on the basis of the disaster prevention information. The radio reception unit 202 generates the reception data on the basis of information indicating an importance level of a content included in the disaster prevention information and a sentence representing the content. FIG. 2A exemplifies a format of the reception data. The reception data is constituted by a 2-bit header part and 1-kilobyte text part. The header part includes header information indicating the importance level of the content of the disaster prevention information. Since the header part has 2 bits, a plurality of importance levels are set. According to the present embodiment, four levels are set. The text part includes the sentence representing the specific content of the disaster prevention information. FIG. 2B illustrates specific examples of the header part and the text part of the disaster prevention information.

In a case where the header information is “00”, an “importance level 0” is set, which represents that an alert level of the disaster prevention information is a notice level. Specifically, the disaster prevention information corresponds to such a content that “tomorrow is a voting day for the ward assembly election” as in a text example. In a case where the header information is “01”, an “importance level 1” is set, which represents that the alert level of the disaster prevention information is an advisory level. Specifically, the disaster prevention information corresponds to such a content that “heavy rain advisory is issued in the southern part of Ibaraki prefecture” as in a text example. In a case where the header information is “10”, an “importance level 2” is set, which represents that the alert level of the disaster prevention information is a warning level. Specifically, the disaster prevention information corresponds to such a content that “heavy rain and flood warning is issued in the 23 wards in Tokyo” as in a text example. In a case where the header information is “11”, an “importance level 3” is set, which represents that the alert level of the disaster prevention information is a high urgency and importance level such as an earthquake or tidal wave. Specifically, the disaster prevention information corresponds to such a content that “earthquake with an intensity of five or above in the seven-point Japanese scale may possibly occur in the southern part of Ibaraki prefecture” as in a text example. With regard to the text part, sentences as in the exemplified texts of FIG. 2B are encoded and stored. The encoding is performed by using, for example, Shift_JIS code.

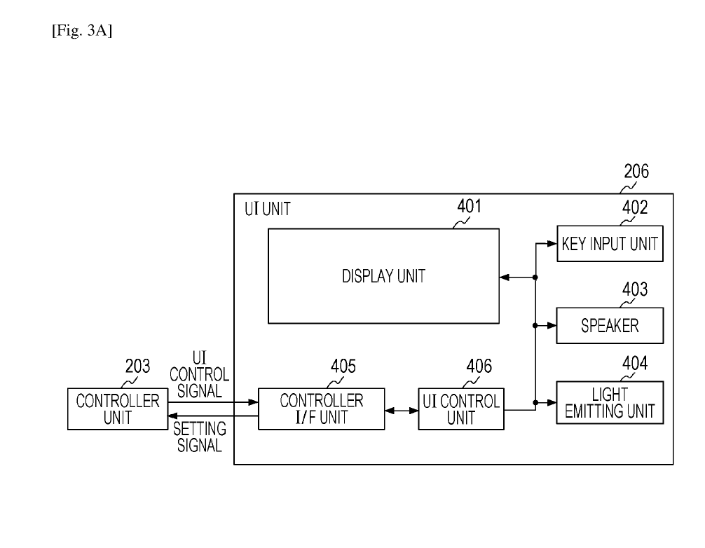

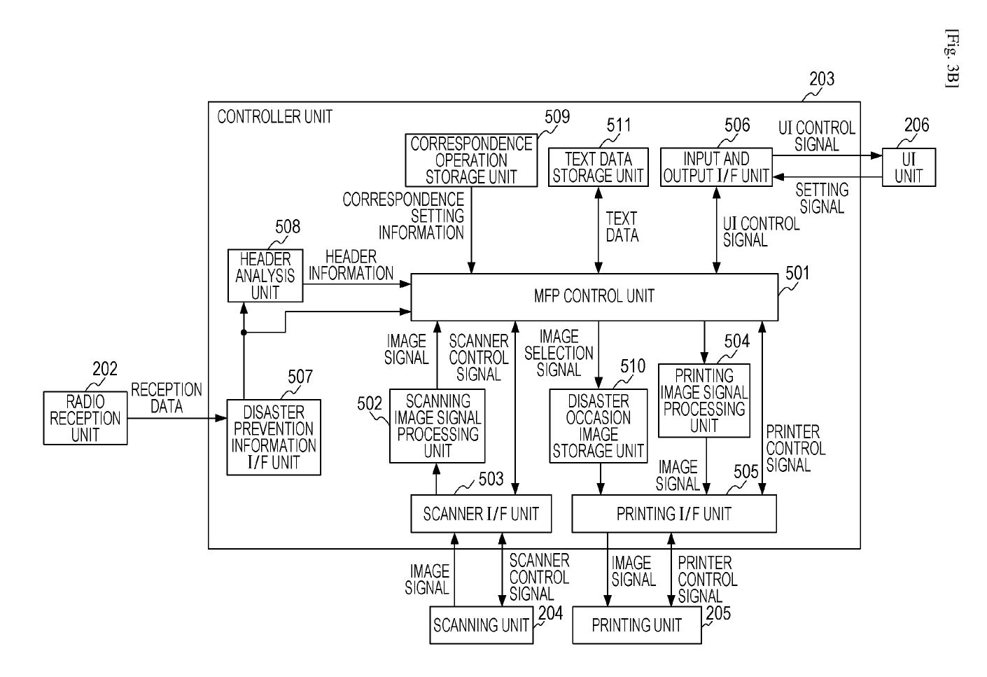

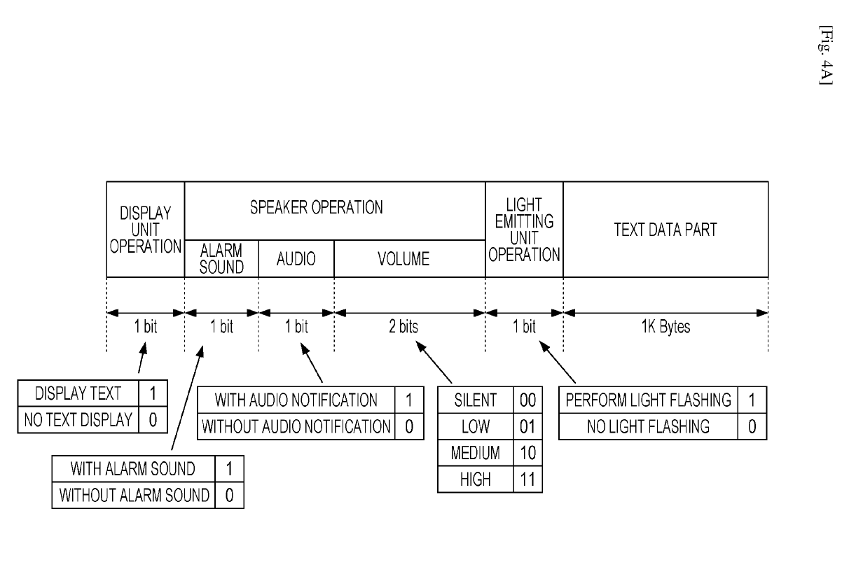

FIGS. 3A and 3B are specific configuration illustrative diagrams of the UI unit 206 and the controller unit 203 in the MFP 100. FIG. 3A illustrates a configuration of the UI unit 206, and FIG. 3B illustrates a configuration of the controller unit 203.

As described above, the UI unit 206 is provided with a display unit 401, a key input unit 402 such as a button, a switch, or a numerical keypad, a speaker 403, and a light emitting unit 404. In addition, the UI unit 206 includes a controller I/F unit 405 and a UI control unit 406.

The display unit 401 is constituted by a display such as a liquid crystal panel and performs display of a character or an image. The key input unit 402 uses a switch or the like of a push button style and performs power supply switch, mode selection, input by way of the numerical keypad, or the like. Part of functions of the key input unit 402 can be substituted by a touch panel. The speaker 403 is a sound output device that produces beep sound or the like at the time of a key touch or an error. The light emitting unit 404 lights up when the power supply is input, flashing occurs at the time of interruption, a fault occurs such as jamming or running-out of sheets, or the like.

The controller I/F unit 405 is an interface configured to obtain the UI control signal from the controller unit 203. The UI control unit 406 performs operation control of the display unit 401, the speaker 403, and the light emitting unit 404 in accordance with the UI control signal obtained via the controller I/F unit 405. According to the present embodiment, the UI control unit 406 performs the notification of the disaster prevention information by the display unit 401, the speaker 403, and the light emitting unit 404 in accordance with the UI control signal. The UI control unit 406 also inputs setting signals representing various settings input by the key input unit 402 or the touch panel to the controller unit 203 via the controller I/F unit 405.

When the disaster prevention information is received, the controller unit 203 performs processing such as saving or notification of the sentence of the text part or printout of previously registered associated information. For this reason, the controller unit 203 analyzes the header part of the received disaster prevention information to select a notification mode based on an analysis result, determine the presence or absence of execution of the saving of the text part, or determine the presence or absence of execution of the printout. In order to perform the above-described processing, the controller unit 203 includes an MFP control unit 501, a header analysis unit 508, a correspondence operation storage unit 509, a text data storage unit 511, a scanning image signal processing unit 502, a disaster occasion image storage unit 510, and a printing image signal processing unit 504. In addition, the controller unit 203 includes a scanner I/F unit 503, a printing I/F unit 505, an input and output I/F unit 506, and a disaster prevention information I/F unit 507 to communicate with the respective units in the MFP 100.

The MFP control unit 501 controls the operation of the entire MFP 100. For this reason, the MFP control unit 501 performs communications with the respective units in the controller unit 203. The MFP control unit 501 is constituted by a control apparatus such as a CPU.

The scanner I/F unit 503 is an interface configured to control the communication between the scanning unit 204 and the MFP control unit 501. The scanner I/F unit 503 receives the scanner control signal for controlling the operation of the scanning unit 204 from the MFP control unit 501 to be transmitted to the scanning unit 204. The scanner I/F unit 503 receives the image signal generated by the scanning unit 204 from the scanning unit 204 to be transmitted to the MFP control unit 501. The scanning image signal processing unit 502 performs predetermined image processing on the image signal obtained from the scanning unit 204 via the scanner I/F unit 503. The scanning image signal processing unit 502 inputs the image signal after the image processing to the MFP control unit 501.

The printing I/F unit 505 is an interface configured to control the communication between the printing unit 205 and the MFP control unit 501. The printing I/F unit 505 receives the printer control signal for controlling the operation of the printing unit 205 from the MFP control unit 501 to be transmitted to the printing unit 205. The printing I/F unit 505 obtains the image signal representing an image to be printed and output to the printing unit 205 from the disaster occasion image storage unit 510 and the printing image signal processing unit 504 and transmits the image signal to the printing unit 205. The printing image signal processing unit 504 performs predetermined image processing on the image signal corresponding to a printing target which is input from the MFP control unit 501. The disaster occasion image storage unit 510 stores a disaster occasion image printed and output from the printing unit 205 at the time of the reception of the disaster prevention information.

The input and output I/F unit 506 is an interface configured to control the communication between the UI unit 206 and the MFP control unit 501. The input and output I/F unit 506 receives a setting signal from the UI unit 206 to be transmitted to the MFP control unit 501. The input and output I/F unit 506 receives the UI control signal for controlling the operation of the UI unit 206 from the MFP control unit 501 to be transmitted to the UI unit 206.

At the time of the reception of the disaster prevention information, the UI control signal for causing the UI unit 206 to perform the notification of the disaster prevention information in a notification mode in accordance with the importance level of the disaster prevention information is transmitted from the MFP control unit 501 to the UI unit 206 via the input and output I/F unit 506. The UI unit 206 performs the display of the sentence of the text part by the display unit 401, audio output of an alarm sound or the sentence of the text part by the speaker 403, a volume adjustment of the speaker 403, and flashing control of the light emitting unit 404 in accordance with the UI control signal. A detail of the UI control signal will be described below.

The disaster prevention information I/F unit 507 obtains the reception data from the radio reception unit 202 to be input to the controller unit 203 and the header analysis unit 508.

The header analysis unit 508 analyzes the header part of the reception data received from the disaster prevention information I/F unit 507. The header analysis unit 508 recognizes the importance level of the disaster prevention information on the basis of high-order 2-bit data corresponding to the header part of the reception data. The header analysis unit 508 inputs the 2-bit data to the MFP control unit 501 as the header information indicating the analysis result. A relationship between the 2 bits of the header information and the importance level is similar to the relationship illustrated in FIG. 2B.

The correspondence operation storage unit 509 stores correspondence setting information in which data indicating the notification mode, whether or not the text is saved, the presence or absence of the printout, or the like is set corresponding to the importance level of the disaster prevention information. The text data storage unit 511 stores text data representing the sentence of the text part of the disaster prevention information.

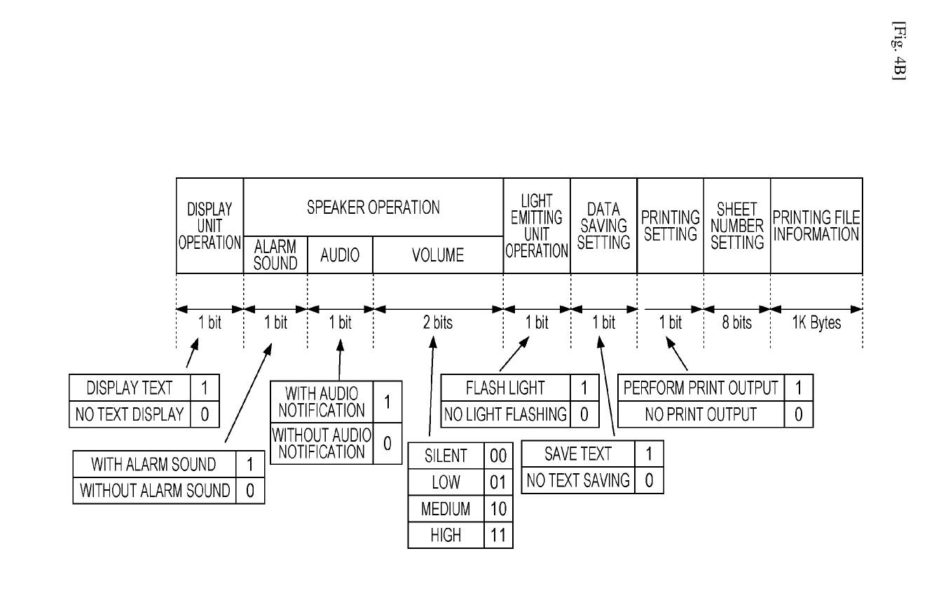

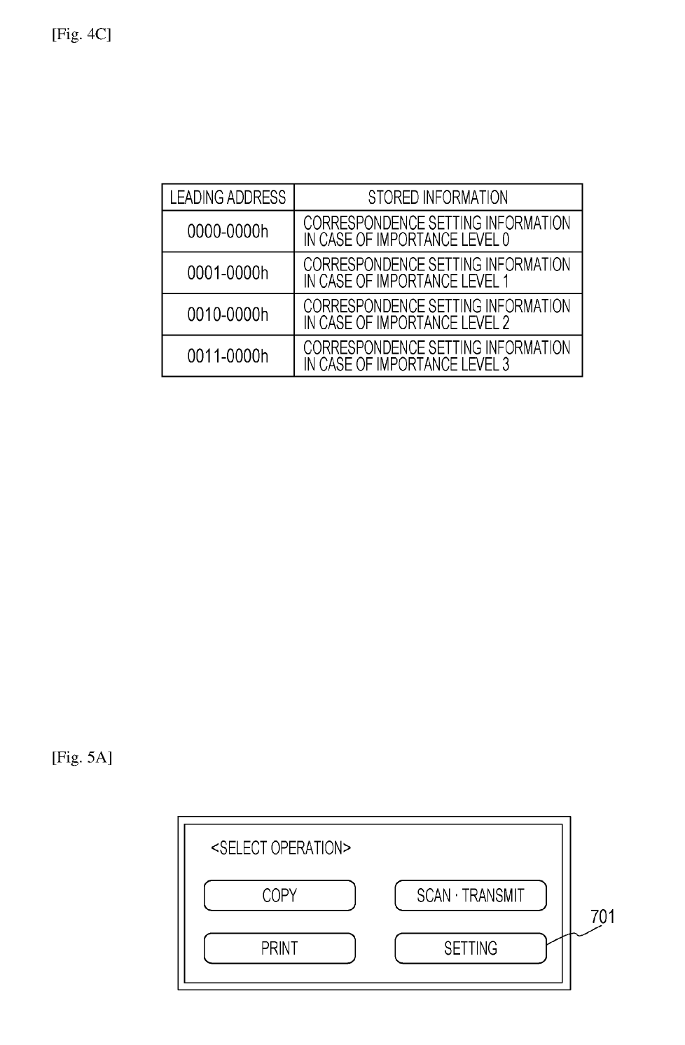

FIGS. 4A to 4C are explanatory diagrams for describing the UI control signal and the correspondence setting information.

FIG. 4A is a data configuration illustrative diagram of the UI control signal transmitted from the controller unit 203 to the UI unit 206. The UI control signal includes data of a “display unit operation”, a “speaker operation”, a “light emitting unit operation”, and a “text data part”.

In the “display unit operation”, a setting is performed on whether or not the sentence of the text part of the reception data is displayed on the display unit 401 of the UI unit 206. The display unit operation is represented by 1-bit data. For example, the “display unit operation” represents “no text display” in the case of “0” and “display text” in the case of “1”.

In the “speaker operation”, a setting is performed on whether or not the output of the alarm sound from the speaker 403 is performed, whether or not the sentence of the text part of the reception data is output as audio, and the volume of the speaker 403. The setting on whether or not the output of the alarm sound is performed is represented by 1-bit data. For example, the “alarm sound” of the “speaker operation” represents “without alarm sound” in the case of “0” and “with alarm sound” in the case of “1”. The setting on whether or not the sentence of the text part of the reception data is output as the audio from the speaker 403 is represented by 1-bit data. For example, the “audio” of the “speaker operation” represents “without audio notification” in the case of “0” and “with audio notification” in the case of “0”. The setting on the volume is represented by 2-bit data. For example, the “volume” of the “speaker operation” represents “silent” as the volume of the speaker in the case of “00”, “low” as the volume of the speaker in the case of “01”, “medium” as the volume of the speaker in the case of “10”, and “high” as the volume of the speaker in the case of “11”.

In the “light emitting unit operation”, a setting is performed on whether or not a light emitting operation such as flashing is performed with respect to the light emitting unit 404. The “light emitting unit operation” is represented by 1-bit data. For example, the “light emitting unit operation” represents “no light flashing of the light emission unit” in the case of “0” and “perform light flashing of the light emission unit” in the case of “1”.

In addition to the above, the UI control signal includes the sentence of the text part of the reception data for displaying the sentence of the text part on the display unit 401 of the UI unit 206 and also reading out the sentence from the speaker 403 as the audio in the “text data part”. The sentence of the text part is converted by the UI control unit 406 of the UI unit 206 from the Shift_JIS code into text data to be displayed on the display unit 401 or audio data to be read out by the speaker 403.

FIG. 4B is a data configuration illustrative diagram of the correspondence setting information stored in the correspondence operation storage unit 509. The correspondence setting information has a configuration obtained by adding a “data saving setting”, a “printing setting”, a “sheet number setting”, and “printing file information” to a high-order 6-bit configuration of the UI control signal. Descriptions will be omitted on a similar configuration to the UI control signal. The correspondence setting information is stored to have the same configuration for each of the importance levels.

In the “data saving setting”, a setting is performed on whether or not the sentence data of the text part is stored in the text data storage unit 511 of the controller unit 203 at the time of the reception of the disaster prevention information. The “data saving setting” is represented by 1-bit data. For example, the “data saving setting” represents “no text saving” in the case of “0” and “save text” in the case of “1”.

In the “printing setting”, a setting is performed on whether or not the disaster occasion image stored in the disaster occasion image storage unit 510 of the controller unit 203 is printed and output at the time of the reception of the disaster prevention information. The “printing setting” is represented by 1-bit data. For example, the “printing setting” represents “no print output” in the case of “0” and “perform print output” in the case of “1”.

In the “sheet number setting”, a setting is performed on the number of output sheets when the print output of the disaster occasion image is performed at the time of the reception of the disaster prevention information. According to the present embodiment, the “sheet number setting” is represented by 8-bit data, and the output sheets up to a maximum of 255 sheets can be set.

In the “printing file information”, an image signal when the print output of the disaster occasion image is performed is specified at the time of the reception of the disaster prevention information. The “printing file information” is represented by location information such as a directory of the image signal in the disaster occasion image storage unit 510, a file name, or the like.

The correspondence operation storage unit 509 that stores the correspondence setting information having the above-described configuration is constituted by a storage device such as a memory. FIG. 4C is an illustrative diagram of a leading address of the correspondence setting information for each of the importance levels stored in the correspondence operation storage unit 509. In an example of FIG. 4C, while an address “0000-0000 h” of the correspondence operation storage unit 509 is set as a leading address, the correspondence setting information in the case of the importance level 0 is stored. While an address “0001-0000 h” of the correspondence operation storage unit 509 is set as a leading address, the correspondence setting information in the case of the importance level 1 is stored. While an address “0010-0000 h” of the correspondence operation storage unit 509 is set as a leading address, the correspondence setting information in the case of the importance level 2 is stored. While an address “0011-0000 h” of the correspondence operation storage unit 509 is set as a leading address, the correspondence setting information in the case of the importance level 3 is stored.

In a case where the header information from the header analysis unit 508 is “00”, the MFP control unit 501 generates the UI control signal on the basis of the correspondence setting information in which “0000-0000 h” is set as the leading address as the “importance level 0”. In a case where the header information from the header analysis unit 508 is “01”, the MFP control unit 501 generates the UI control signal on the basis of the correspondence setting information in which “0001-0000 h” is set as the leading address as the “importance level 1”. In a case where the header information from the header analysis unit 508 is “10”, the MFP control unit 501 generates the UI control signal on the basis of the correspondence setting information in which “0010-0000 h” is set as the leading address as the “importance level 2”. In a case where the header information from the header analysis unit 508 is “11”, the MFP control unit 501 generates the UI control signal on the basis of the correspondence setting information in which “0011-0000 h” is set as the leading address as the “importance level 3”

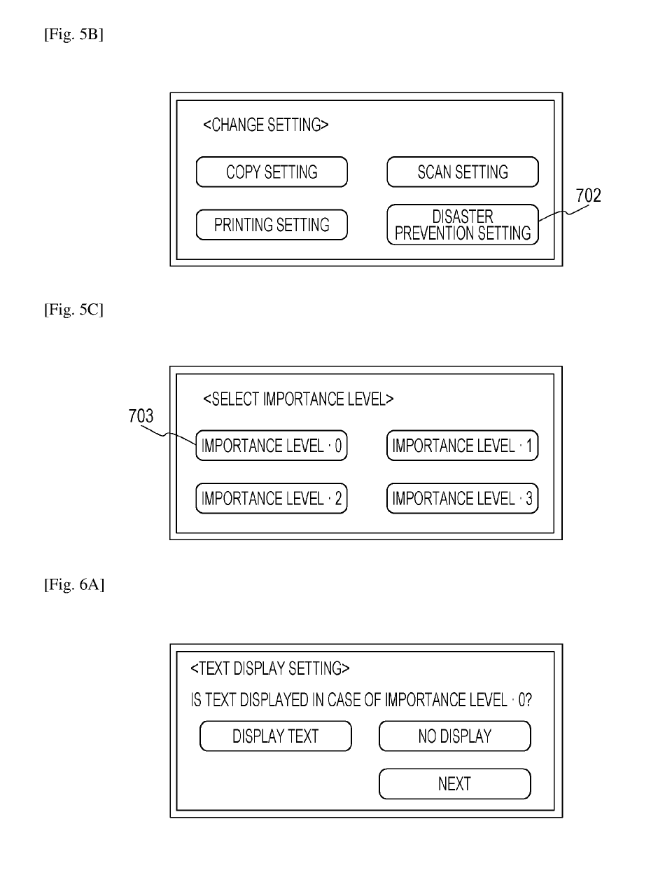

The correspondence setting information is set by the setting signal input from the UI unit 206. FIGS. 5A to 5C, FIGS. 6A to 6I, and FIGS. 7A to 7C are illustrative diagrams of a setting screen displayed on the display unit 401 of the UI unit 206 at the time of the setting of the correspondence setting information. The user appropriately performs a selection by using the touch panel, the key input unit 402, or the like from these setting screen to set the correspondence setting information.

FIG. 5A illustrates a default screen displayed on the display unit 401 at the time of a normal operation of the MFP 100. This screen is a screen for selecting an operation of the MFP 100. The user can select various settings from this screen in addition to basic operations of the MFP 100 such as copying, printing, and transmission by way of email of a scanned image. In a case where the setting of the correspondence setting information is performed, the user selects a “setting” button 701. When the “setting” button 701 of FIG. 5A is selected, a screen of FIG. 5B is displayed on the display unit 401.

FIG. 5B illustrates a screen for performing a setting at the time of the reception of the disaster prevention information in addition to operation settings of copying, printing, and scanning. The user performs the setting by selecting copying, printing, scanning, or the time of the reception of the disaster prevention information from this screen. When a “disaster prevention setting” button 702 of FIG. 5B is selected, a screen of FIG. 5C is displayed on the display unit 401.

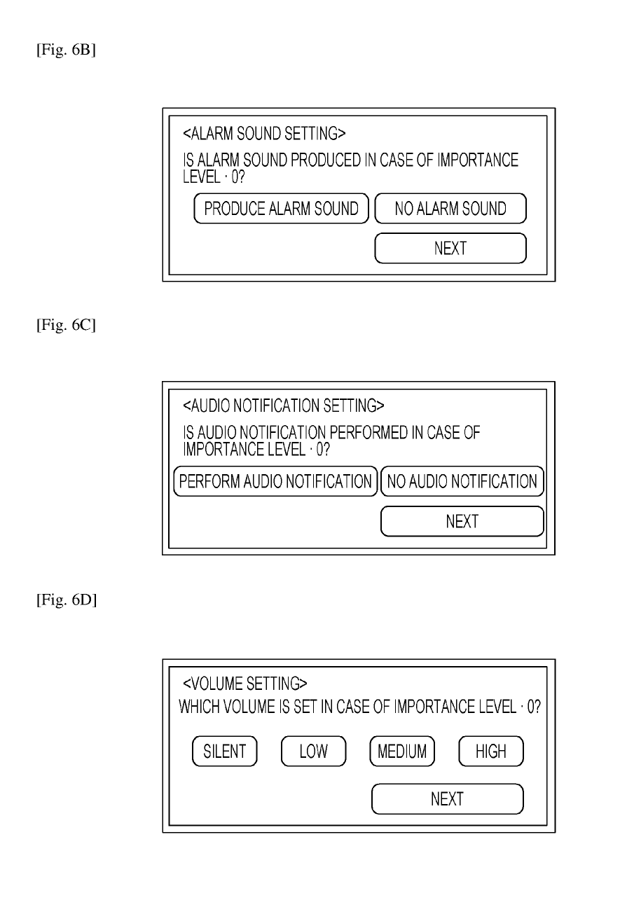

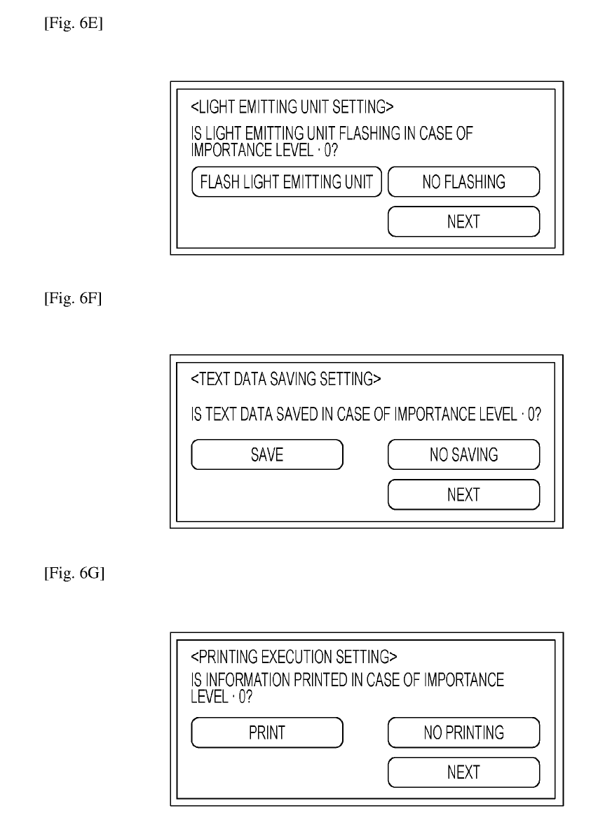

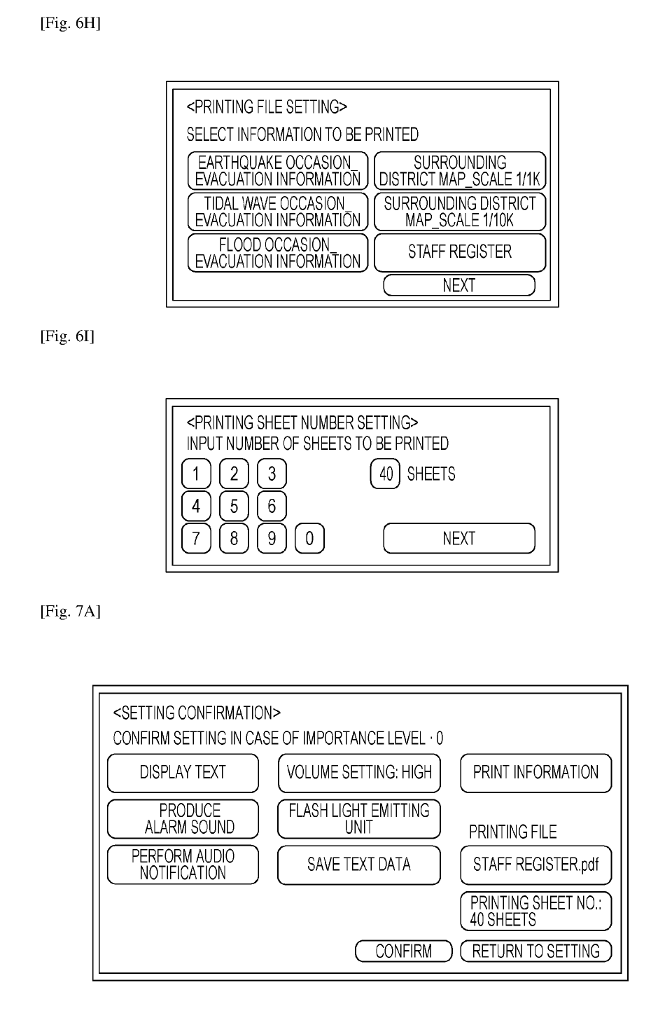

FIG. 5C illustrates a screen for performing a setting for each of the importance levels. The user selects the importance level 0, 1, 2, or 3 from this screen to perform the setting. Here, an example will be described in which the user selects an “importance level●0” button 703, and the correspondence setting information corresponding to the importance level 0 is set. Similar processing is also performed with regard to the other importance levels. FIGS. 6A to 6I are illustrative diagrams of the screen for setting the correspondence setting information when the importance level is “0”.

FIG. 6A illustrates a screen for performing a setting on whether or not the sentence of the text part of the reception data is displayed on the display unit 401. The user selects either “display text” or “no display”. When “perform display” is selected, “1” is set in the “display unit operation” of the correspondence setting information. Accordingly, the UI unit 206 converts the sentence of the text data part of the UI control signal illustrated in FIG. 4A from the Shift_JIS code into text data to be displayed on the display unit 401. In a case where “no display” is selected, “0” is set in the “display unit operation” of the correspondence setting information. When a “next” button is pressed, the screen is shifted to the setting screen for the next item of the correspondence setting information.

FIG. 6B illustrates a screen for performing a setting on whether or not the alarm sound is output from the speaker 403. The user selects either “produce alarm sound” or “no alarm sound”. In a case where “produce alarm sound” is selected, “1” is set in the “alarm sound” of the “speaker operation” of the correspondence setting information. In a case where “no alarm sound” is selected, “0” is set in the “alarm sound” of the “speaker operation” of the correspondence setting information. When the “next” button is pressed, the screen is shifted to the setting screen for the next item of the correspondence setting information.

FIG. 6C illustrates a screen for performing a setting on whether or not audio notification of the sentence of the text part of the reception data is performed from the speaker 403. The user selects either “perform audio notification” or “no audio notification”. In a case where “perform audio notification” is selected, “1” is set in the “audio” of the “speaker operation” of the correspondence setting information. Accordingly, the UI unit 206 converts the sentence of the text data part of the UI control signal illustrated in FIG. 4A from the Shift_JIS code into audio data for producing audio from the speaker 403 to be output from the speaker 403. In a case where “no audio notification” is selected, “0” is set in the “audio” of the “speaker operation” of the correspondence setting information. When the “next” button is pressed, the screen is shifted to the setting screen for the next item of the correspondence setting information.

FIG. 6D illustrates a screen for performing a volume setting of the alarm sound or the audio notification output from the speaker 403. According to the present embodiment, the volume can be set in four stages including “silent”, “low”, “medium”, and “high”. In a case where “silent” is selected, even when the alarm sound or the audio notification is set, the volume becomes zero to establish a state in which the alarm sound or the audio notification is not heard. The user selects “silent”, “low”, “medium”, or “high”. In a case where “silent” is selected, “00” is set in the “volume” of the “speaker operation” of the correspondence setting information. In a case where “low” is selected, “01” is set in the “volume” of the “speaker operation” of the correspondence setting information. In a case where “medium” is selected, “10” is set in the “volume” of the “speaker operation” of the correspondence setting information. In a case where “high” is selected, “11” is set in the “volume” of the “speaker operation” of the correspondence setting information. When the “next” button is pressed, the screen is shifted to the setting screen for the next item of the correspondence setting information.

FIG. 6E illustrates a screen for performing a setting on whether or not the notification of the disaster prevention information is performed by way of flashing of the light emitting unit 404. The user selects either “flash light emitting unit” or “no flashing”. In a case where “flash light emitting unit” is selected, “1” is set in the “light emitting unit operation” of the correspondence setting information. In a case where “no flashing” is selected, “0” is set in the “light emitting unit operation” of the correspondence setting information. When the “next” button is pressed, the screen is shifted to the setting screen for the next item of the correspondence setting information.

FIG. 6F illustrates a screen for performing a setting on whether or not the sentence of the text part of the reception data is saved. The user selects either “save” or “no saving”. In a case where “save” is selected, “1” is set in the “data saving setting” of the correspondence setting information. In a case where “no saving” is selected, “0” is set in the “data saving setting” of the correspondence setting information. When the “next” button is pressed, the screen is shifted to the setting screen for the next item of the correspondence setting information.

FIG. 6G illustrates a screen for performing a setting on whether or not print output of the disaster occasion image previously stored in the disaster occasion image storage unit 510 is performed. The user selects either “print” or “no printing”. In a case where “print” is selected, “1” is set in the “printing setting” of the correspondence setting information. In a case where “no printing” is selected, “0” is set in the “printing setting” of the correspondence setting information. When the “next” button is pressed, the screen is shifted to the setting screen for the next item of the correspondence setting information.

FIG. 6H illustrates a screen displayed when the “next” button is pressed after “print” is selected in FIG. 6G. FIG. 6H is a screen for selecting the image signal to be printed and output from among a plurality of image signals representing the disaster occasion images stored in the disaster occasion image storage unit 510. A list of the image signals of the disaster occasion images stored in the disaster occasion image storage unit 510 is displayed on the display unit 401. The user selects the image signal to be printed from this list. A plurality of image signals can be selected from the list of the image signal. A selection result is set in the “printing file information” of the correspondence setting information. When the “next” button is pressed, the screen is shifted to the setting screen for the next item of the correspondence setting information.

FIG. 6I illustrates a screen displayed when the “next” button of FIG. 6H is pressed. FIG. 6I is a screen for setting the number of sheets to be printed and output. The display unit 401 displays a numerical keypad for setting the number of sheets. The user performs the setting on the number of sheets by using the numerical keypad. According to the present embodiment, since 8-bit setting information is used for the setting on the number of sheets, the maximum setting number of sheets is 255. The setting result is set in the “sheet number setting” of the correspondence setting information. When the “next” button is pressed, the screen is shifted to the setting screen for the next item of the correspondence setting information.

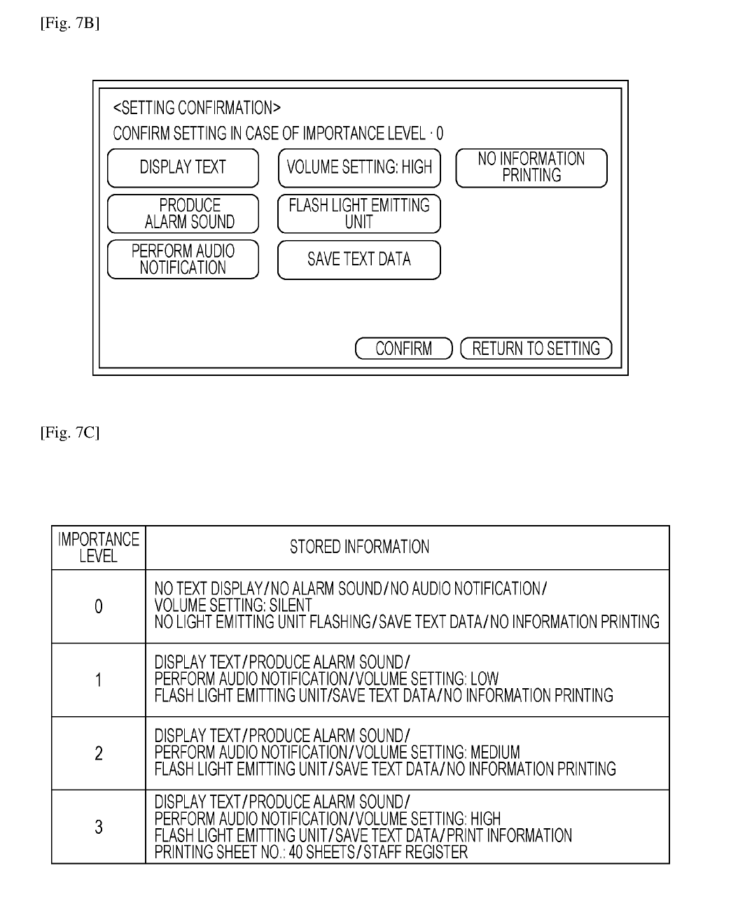

FIG. 7A illustrates a screen for confirming the correspondence setting information in a case where the print output is performed. This screen is displayed when the “next” button of FIG. 6I is pressed. The user confirms the setting content by using this screen. When the setting content is correct, the user selects “confirm”, and when the setting content is incorrect, the user performs the setting again. In a case where the user performs the setting again, the user presses a “return to setting” button. When the “return to setting” button is pressed, the screen is shifted to the setting screen of FIG. 6A. In a case where the “confirm” button is selected, the correspondence setting information having this content is stored in the correspondence operation storage unit 509.

FIG. 7B illustrates a screen for confirming the correspondence setting information in a case where the print output is not performed. This screen is displayed when the “next” button is pressed after “no printing” is selected in FIG. 6G. The user confirms the setting content by using this screen. When the setting content is correct, the user selects “confirm”, and when the setting content is incorrect, the user performs the setting again. In a case where the user performs the setting again, the user presses a “return to setting” button. When the “return to setting” button is pressed, the screen is shifted to the setting screen of FIG. 6A. In a case where the “confirm” button is selected, the correspondence setting information having this content is stored in the correspondence operation storage unit 509.

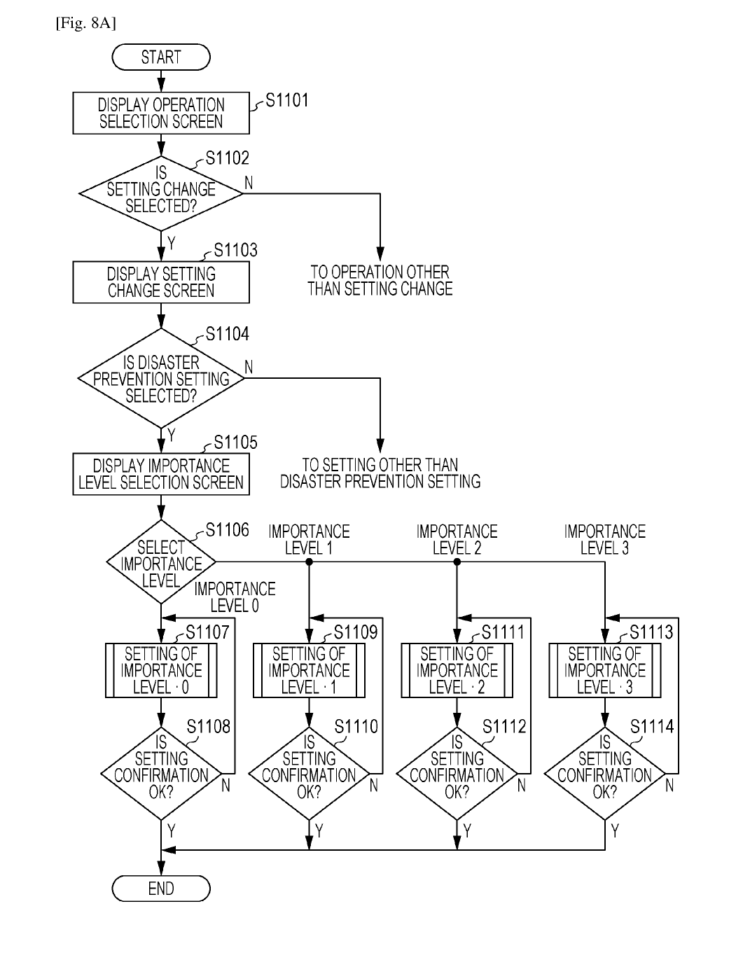

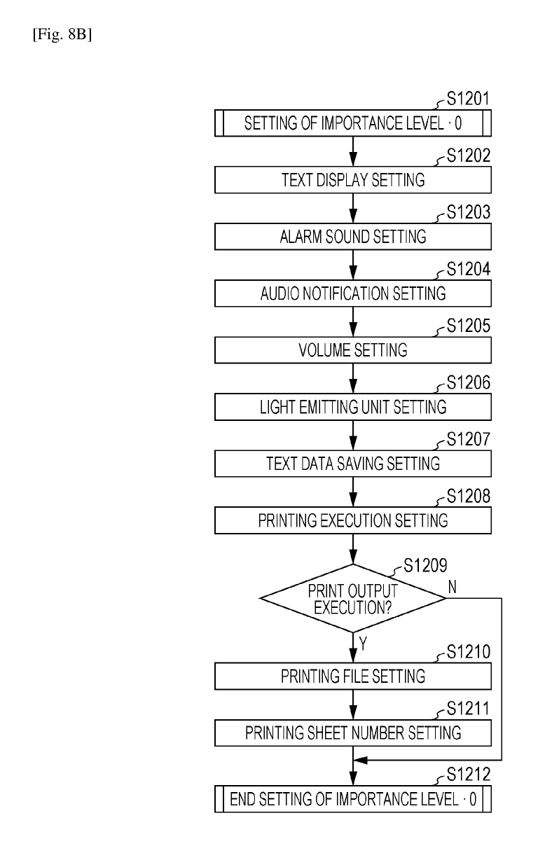

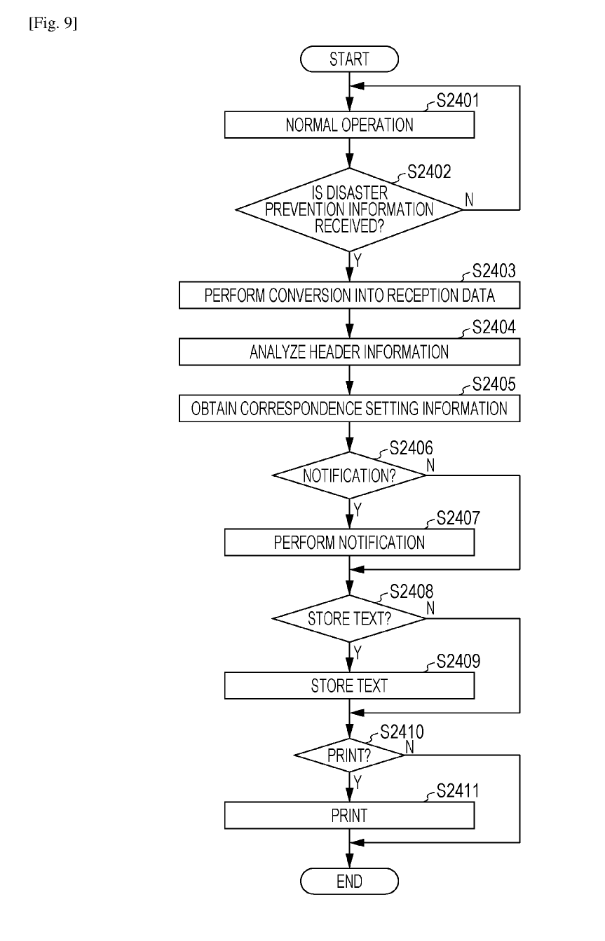

FIG. 7C is an illustrative diagram of the correspondence setting information corresponding to each of the importance levels generated by the above-described operation on the screen. FIGS. 8A and 8B are flow charts illustrating setting processing of the above-described correspondence setting information. At the time of the setting processing of the correspondence setting information, the screens described with reference to FIGS. 5A to 5C, FIGS. 6A to 6I, and FIGS. 7A to 7C are displayed on the display unit 401. The user sets the correspondence setting information by performing the selection in accordance with this screen. The setting processing of the correspondence setting information is normally performed in a state in which the MFP 100 is activated and does not perform processing such as the image forming processing. The UI unit 206 displays the screen on the display unit 401 in accordance with the UI control signal input from the MFP control unit 501.

The operation selection screen of FIG. 5A is displayed on the display unit 401 of the UI unit 206 (S1101). The MFP control unit 501 obtains the selection result on the operation selection screen by the user. When the user presses the “setting” button 701 from the operation selection screen, the MFP control unit 501 determines that the setting change is selected (S1102: Y). In this case, the MFP control unit 501 displays the setting change screen of FIG. 5B on the display unit 401 (S1103). It should be noted that, in a case where the user presses a button other than the “setting” button 701, it is determined that processing associated with the pressed button is selected, and the MFP control unit 501 executes this processing (S1102: N).

The MFP control unit 501 obtains the selection result on the operation selection screen by the user. When the user presses the “disaster prevention setting” button 702 from the setting change screen, the MFP control unit 501 determines that the disaster prevention setting is selected (S1104: Y). In this case, the MFP control unit 501 displays the importance level selection screen of FIG. 5C on the display unit 401 (S1105). It should be noted that, in a case where the user presses a button other than the “disaster prevention setting” button 702, it is determined that the setting at the time of the operation of copying, printing, or scanning is selected, the MFP control unit 501 causes the user to perform the setting of this processing (S1104: N).

The MFP control unit 501 obtains the selection result on the importance level selection screen by the user. The user selects the “importance level●0”, the “importance level●1”, the “importance level●2”, or the “importance level●3” from the importance level selection screen. The MFP control unit 501 determines the selection result (S1106). In a case where the user selects the “importance level●0” (S1106: the importance level 0), the MFP control unit 501 performs the setting processing of the correspondence setting information when the importance level is “0” (S1107). When the user confirms the setting content without any issues (S1108: Y), the MFP control unit 501 stores the correspondence setting information having the set content when the importance level is “0” in the correspondence operation storage unit 509 and ends the setting processing.

In a case where the user selects the “importance level●1” (S1106: the importance level 1), the MFP control unit 501 performs the setting processing of the correspondence setting information when the importance level is “1” (S1109). When the user confirms the setting content without any issues (S1110: Y), the MFP control unit 501 stores the correspondence setting information having the set content when the importance level is “1” in the correspondence operation storage unit 509 and ends the setting processing.

In a case where the user selects the “importance level●2” (S1106: the importance level 2), the MFP control unit 501 performs the setting processing of the correspondence setting information when the importance level is “2” (S1111). When the user confirms the setting content without any issues (S1112: Y), the MFP control unit 501 stores the correspondence setting information having the set content when the importance level is “2” in the correspondence operation storage unit 509 and ends the setting processing.

In a case where the user selects the “importance level●3” (S1106: the importance level 3), the MFP control unit 501 performs the setting processing of the correspondence setting information when the importance level is “3” (S1113). When the user confirms the setting content without any issues (S1114: Y), the MFP control unit 501 stores the correspondence setting information having the set content when the importance level is “3” in the correspondence operation storage unit 509 and ends the setting processing.

When the setting processing of the correspondence setting information is ended, the MFP control unit 501 displays the operation selection screen of FIG. 5A on the display unit 401 of the UI unit 206.

FIG. 8B is a flow chart illustrating the setting processing of the correspondence setting information when the importance level is “0”. In the case of the other importance levels “1”, “2”, and “3” too, the MFP control unit 501 sets the correspondence setting information by the similar processing. Descriptions of the processing in the case of the other importance levels will be omitted.

When the user selects the “importance level●0”, the MFP control unit 501 displays a text display setting screen of FIG. 6A on the display unit 401 of the UI unit 206 (S1201). The MFP control unit 501 obtains the “display unit operation” of the correspondence setting information of FIG. 4B in accordance with the selection result on the text display setting screen by the user and sets the selection result (S1202). When the “next” button of the text display setting screen is pressed, the MFP control unit 501 displays an alarm sound setting screen of FIG. 6B on the display unit 401.

The MFP control unit 501 obtains the selection result on the alarm sound setting screen by the user and sets the “alarm sound” of the “speaker operation” of the correspondence setting information of FIG. 4B in accordance with the selection result (S1203). When the “next” button on the alarm sound setting screen is pressed, the MFP control unit 501 displays an audio notification setting screen of FIG. 6C on the display unit 401. The MFP control unit 501 obtains the selection result on the audio notification setting screen by the user and the “audio” of the “speaker operation” of the correspondence setting information of FIG. 4B in accordance with the selection result (S1204). When the “next” button on the audio notification setting screen is pressed, the MFP control unit 501 displays a volume setting screen of FIG. 6D on the display unit 401. The MFP control unit 501 obtains the selection result on the volume setting screen by the user and sets the “volume” of the “speaker operation” of the correspondence setting information of FIG. 4B in accordance with the selection result (S1205). When the “next” button on the volume setting screen is pressed, the MFP control unit 501 displays a light emitting unit setting screen of FIG. 6E on the display unit 401.

The MFP control unit 501 obtains the selection result on the light emitting unit setting screen by the user and sets the “light emitting unit operation” of the correspondence setting information of FIG. 4B in accordance with the selection result (S1206). When the “next” button on the light emitting unit setting screen is pressed, the MFP control unit 501 displays a text data saving setting screen of FIG. 6F on the display unit 401.

The MFP control unit 501 obtains the selection result on the text data saving setting screen by the user and sets the “data saving setting” of the correspondence setting information of FIG. 4B in accordance with the selection result (S1207). When the “next” button on the text data saving setting screen is pressed, the MFP control unit 501 displays a printing execution setting screen of FIG. 6G on the display unit 401.

The MFP control unit 501 obtains the selection result on the text data saving setting screen by the user and sets the “data saving setting” of the correspondence setting information of FIG. 4B in accordance with the selection result (S1207). When the “next” button on the text data saving setting screen is pressed, the MFP control unit 501 displays the printing execution setting screen of FIG. 6G on the display unit 401. The MFP control unit 501 obtains the selection result on the printing execution setting screen by the user and sets the “printing setting” of the correspondence setting information of FIG. 4B in accordance with the selection result (S1208). In a case where the setting is made in which the print output is not performed (S1209: N), when the “next” button on the printing execution setting screen is pressed, the MFP control unit 501 displays a setting confirmation screen of FIG. 7B on the display unit 401. In a case where the print output is not performed, the processing in S1107 is ended here. In a case where the setting is made in which the print output is performed (S1209: Y), when the “next” button on the printing execution setting screen is pressed, the MFP control unit 501 displays a printing file setting screen of FIG. 6H on the display unit 401.

The MFP control unit 501 obtains the selection result on the printing file setting screen by the user and sets the “printing file information” of the correspondence setting information of FIG. 4B in accordance with the selection result (S1210). When the “next” button on the printing file setting screen is pressed, the MFP control unit 501 displays a printing sheet number setting screen of FIG. 6I on the display unit 401. The MFP control unit 501 obtains the selection result on the printing sheet number setting screen by the user and sets the “sheet number setting” of the correspondence setting information of FIG. 4B in accordance with the selection result (S1211). Thus, the MFP control unit 501 ends the processing in S1107.

The MFP 100 having the above-described configuration performs the notification processing of the disaster prevention information on the basis of the importance level of the disaster prevention information and the correspondence setting information at the time of the reception of the disaster prevention information. FIG. 9 is a flow chart illustrating the notification processing of the disaster prevention information by the MFP 100.

When the MFP 100 is activated and performs a normal operation, the MFP 100 stands by to receive the disaster prevention information (S2401, S2402). The “normal operation” refers to a state in which a copying operation, a printing operation, or the like is performed, a standby state, a sleeping state, or the like. The standby state refers to a state in which power supply is input to the scanning unit 204, the printing unit 205, the UI unit 206, and the like, but these units are not operated. The sleeping state refers to a state in which power supply is input to only the radio reception unit 202, and power supply is not input to the other units.

In a case where the disaster prevention information is received from the transmitting station 600 (S2402: Y), the MFP 100 converts the disaster prevention information received by the radio reception unit 202 into reception data (S2403). The radio reception unit 202 inputs the reception data to the header analysis unit 508 and the MFP control unit 501. The header analysis unit 508 analyzes the header part of the reception data to recognize an importance level of the disaster prevention information (S2404). The header analysis unit 508 inputs the header information representing the importance level to the MFP control unit 501.

The MFP control unit 501 obtains the correspondence setting information from the correspondence operation storage unit 509 in accordance with the importance level indicated by the header information obtained from the header analysis unit 508 (S2405). The MFP control unit 501 determines whether or not the notification of the disaster prevention information to the user is performed by using the UI unit 206 on the basis of the obtained correspondence setting information (S2406). In a case where the notification of the disaster prevention information is performed (S2406: Y), the MFP control unit 501 performs the display of the sentence by the display unit 401, the output of the audio by the speaker 403, or the like in the notification mode in accordance with the content of the correspondence setting information (S2407).

In a case where the notification of the disaster prevention information is not performed (S2406: N) or after the notification of the disaster prevention information, the MFP control unit 501 determines whether or not the reception data representing the sentence of the text part is stored in accordance with the correspondence setting information (S2408). In a case where the text data is stored (S2408: Y), the MFP control unit 501 stores the text data of the text part of the reception data in the text data storage unit 511 (S2409).

In a case where the text data is not stored (S2408: N) or after the text data is stored, the MFP control unit 501 determines whether or not the disaster occasion image stored in the disaster occasion image storage unit 510 is printed and output in accordance with the correspondence setting information (S2410). In a case where the print output is performed (S2410: Y), the MFP control unit 501 instructs the disaster occasion image storage unit 510 to print the relevant image signal. Accordingly, the relevant image signal is transmitted to the printing unit 205 to perform the print output (S2411). In a case where the print output is not performed (S2410: N) or after the print output is performed, the MFP control unit 501 puts the MFP 100 back to the normal state and ends the processing at the time of the reception of the disaster prevention information.

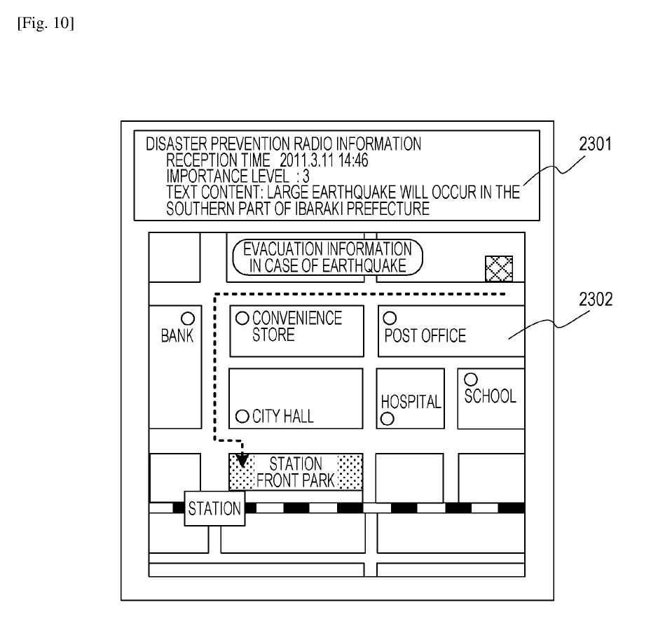

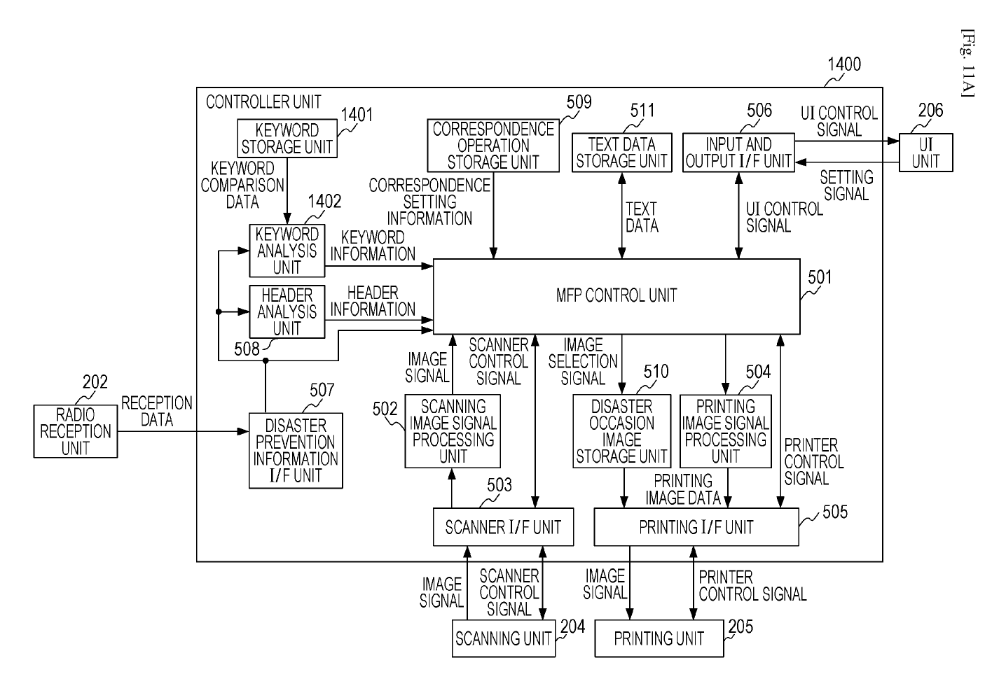

In a case where the print output is performed, the disaster occasion image stored in the disaster occasion image storage unit 510 is printed as it is, but an image obtained by combining the disaster occasion image with the disaster prevention information may be printed and output. FIG. 10 is an illustrative diagram of a printed and output image in which the disaster occasion image stored in the disaster occasion image storage unit 510 and the sentence representing the content of the disaster prevention information are combined with each other. This image includes a sentence 2301 representing the content of the disaster prevention information and a map image 2302 corresponding to the disaster occasion image.

As described above, at the time of the reception of the disaster prevention information, the MFP 100 determines the importance level of the disaster prevention information on the basis of its content and performs the notification of the disaster prevention information in the notification mode in accordance with the importance level. The notification mode includes the display on the display unit 401, the sound output from the speaker 403, the light flashing by the light emitting unit 404, the print output of the image associated with the disaster prevention information, the saving of the text of the disaster prevention information, and the like. The notification mode is set by the correspondence setting information prepared for each of the importance levels. The above-described MFP 100 can perform the appropriate notification to the user in accordance with the disaster prevention information.

### Second Embodiment

The MFP 100 may change the notification mode of the disaster prevention information on the basis of a content of the sentence of the text part in addition to the importance level. This configuration is to cope with a situation where an urgency of the disaster prevention information to the user changes depending on a type, a time, or a subject region of the disaster prevention information. Similarly as in the first embodiment, the MFP 100 according to a second embodiment performs the notification of the disaster prevention information or saving of the sentence of the text part in accordance with the importance level included in the disaster prevention information and also performs the notification of the disaster prevention information or saving of the sentence in accordance with the content of the sentence of the text part of the disaster prevention information in addition to the above.

Sentences included in the disaster prevention information distributed by the disaster prevention radio system are created in a format which is fixed to some extent. For this reason, the sentences include keywords used to recognize contents. Specifically, words related to types of the disasters such as “heavy rain”, “flood”, and “earth quake”, words related to regions such as “southern part of Ibaraki prefecture” and “23 wards”, words related to times such as “tomorrow” and “PM, today”, and the like become keywords for recognizing the contents of the sentences of the text part. According to the second embodiment, the MFP 100 performs the notification of the disaster prevention information in accordance with these keywords.

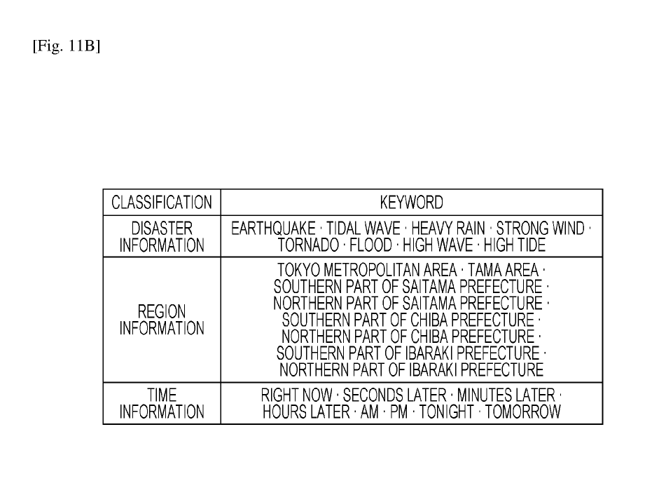

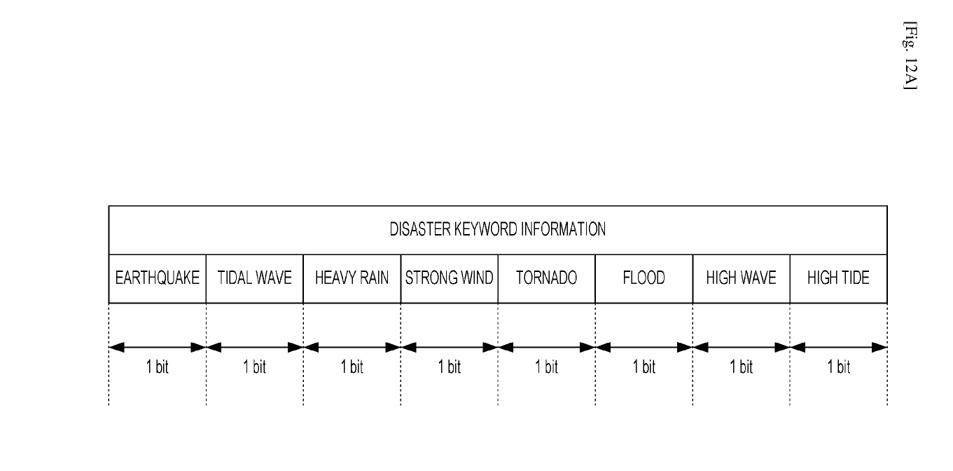

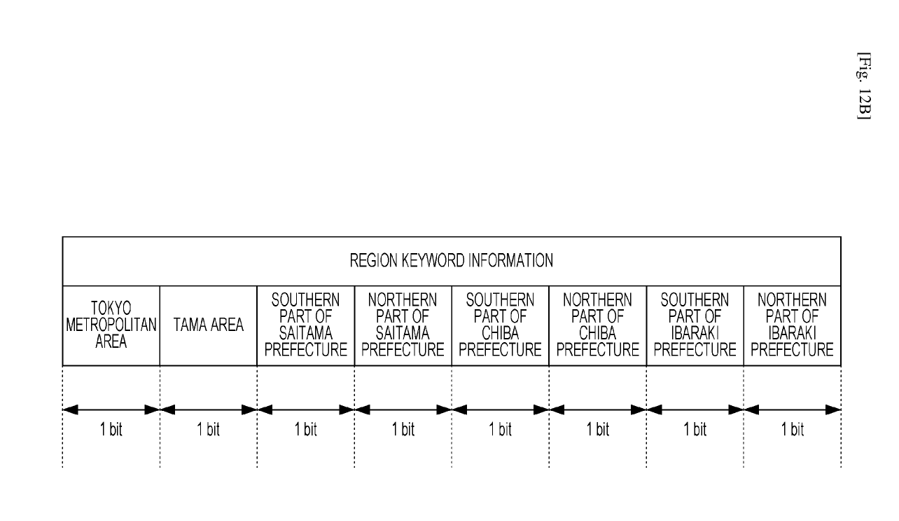

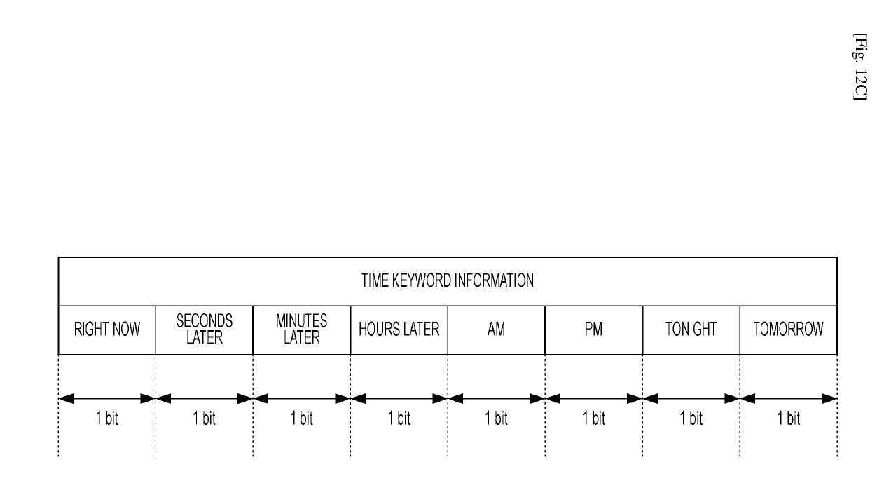

As compared with the disaster prevention radio system according to the first embodiment, the disaster prevention radio system according to the second embodiment has a different configuration of the controller unit of the MFP 100, and the other configurations are similar to each other. Descriptions on the similar configuration to the first embodiment will be omitted. FIGS. 11A and 11B are explanatory diagrams for describing a controller unit 1400 according to the second embodiment included in the MFP 100. FIG. 11A is a schematic diagram of the controller unit 1400. The controller unit 1400 has a configuration obtained by adding a keyword storage unit 1401 and a keyword analysis unit 1402 to the controller unit according to the first embodiment (see FIG. 3B). Descriptions on the other same configuration parts will be omitted.

The keyword storage unit 1401 is constituted by a storage medium such as a memory and stores a keyword for controlling the operation of the MFP 100 at the time of the reception of the disaster prevention information. The keyword stored in the keyword storage unit 1401 becomes a factor for determining the notification mode of the disaster prevention information. FIG. 11B is an illustrative diagram of the key word stored in the keyword storage unit 1401.

The keywords are classified into three types including “disaster information”, “region information”, and “time information” to be stored. The “disaster information” uses, for example, “earth quake●tidal wave●heavy rain●strong wind●tornado●flood●high wave●high tide” as keywords. The “region information” uses, for example, “Tokyo Metropolitan area●Tama area●southern part of Saitama prefecture●northern part of Saitama prefecture●southern part of Chiba prefecture●northern part of Chiba prefecture●southern part of Ibaraki prefecture●northern part of Ibaraki prefecture” as key words. The “time information” uses, for example, “right now●seconds later●minutes later●hours later●AM●PM●tonight●tomorrow” as keywords. Each keyword is stored in the keyword storage unit 1401 as Shift_JIS code.

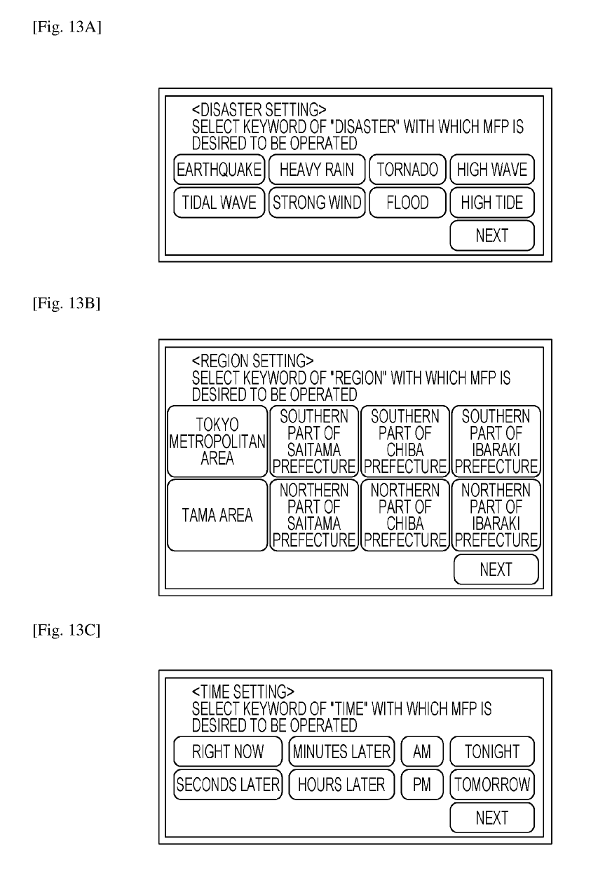

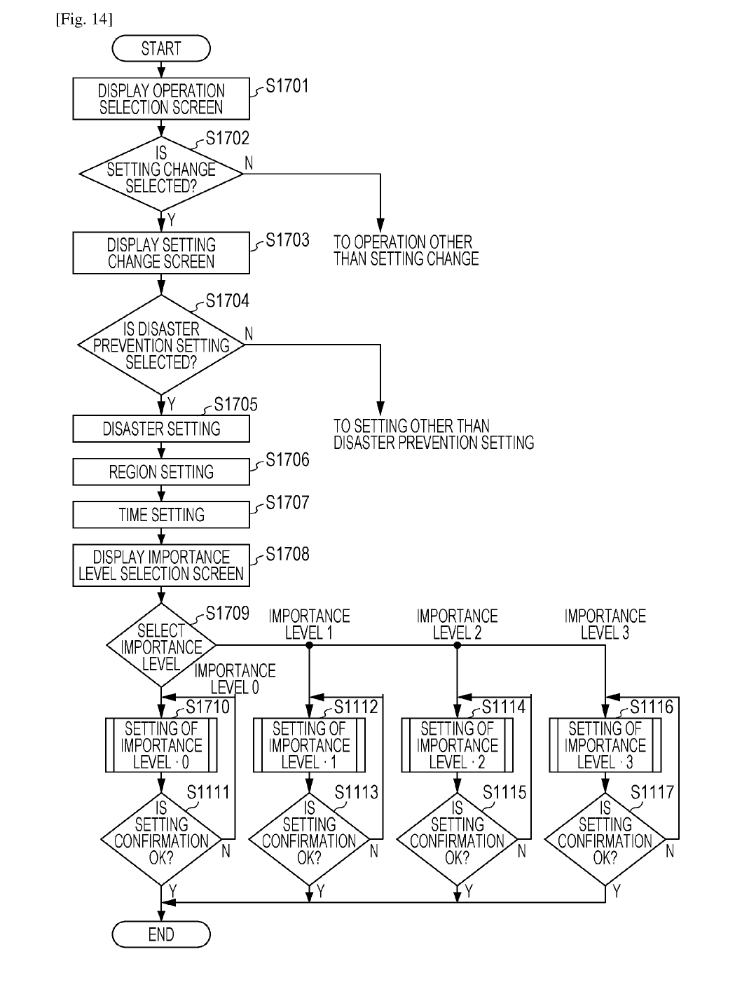

The keyword analysis unit 1402 performs pattern matching between the reception data and the keyword stored in the keyword storage unit 1401 and inputs the presence or absence of a matched keyword to the MFP control unit 501 as keyword information. FIGS. 12A to 12C are explanatory diagrams for describing the keyword information. The keyword analysis unit 1402 generates the keyword information in accordance with the classification of the keyword. According to the present embodiment, since the keywords are classified into three types including the “disaster information”, the “region information”, and the “time information”, three pieces of the “disaster information”, the “region information”, and the “time information” are generated as the keyword information. The three pieces of keyword information are transmitted to the MFP control unit 501 as a set of information.

FIG. 12A illustrates the keyword information related to the disaster information (disaster keyword information). The disaster keyword information is constituted by 8-bit data according to the present embodiment and represents the presence or absence of the respective keywords of earth quake●tidal wave●heavy rain●strong wind●tornado●flood●high wave●high tide from the higher-order bit in the state order. For example, in a case where a word “heavy rain and flood warning” is included in the text part of the received disaster prevention information, the disaster keyword information becomes 8-bit data “00100100”. It should be noted that the number of bits of the disaster keyword information is determined in accordance with the number of the keywords of the disaster information.

FIG. 12B illustrates the keyword information related to the region information (region keyword information). The region keyword information is constituted by 8-bit data according to the present embodiment and represents the presence or absence of the respective keywords of Tokyo Metropolitan area●Tama area●southern part of Saitama prefecture●northern part of Saitama prefecture●southern part of Chiba prefecture●northern part of Chiba prefecture●southern part of Ibaraki prefecture●northern part of Ibaraki prefecture from the higher-order bit in the state order. For example, in a case where a word “23 wards in Tokyo and southern part of Saitama prefecture” is included in the text part of the received disaster prevention information, the region keyword information becomes 8-bit data “10100000”. It should be noted that the number of bits of the region keyword information is determined in accordance with the number of the keywords of the region information.

FIG. 12C illustrates the keyword information related to the time information (time keyword information). The time keyword information is constituted by 8-bit data according to the present embodiment and represents the presence or absence of the respective keywords of right now●seconds later●minutes later●hours later●AM●PM●tonight●tomorrow from the higher-order bit in the state order. For example, in a case where a word “from tonight to tomorrow” is included in the text part of the received disaster prevention information, 8 of the disaster keyword information becomes 8-bit data “00000011”. It should be noted that the number of bits of the time keyword information is determined in accordance with the number of the keywords of the time information.

The MFP control unit 501 determines the notification mode of the disaster prevention information on the basis of the keyword information obtained from the keyword analysis unit 1402, the header information obtained from the header analysis unit 508, the reception data, and the correspondence setting information stored in the correspondence operation storage unit 509. The MFP control unit 501 generates a UI control signal representing the determined notification mode and inputs the UI control signal to the UI unit 206. The UI unit 206 notifies the user of the disaster prevention information in the notification mode in accordance with the UI control signal obtained from the MFP control unit 501.

The correspondence operation storage unit 509 stores keyword setting information corresponding to a comparison target with the keyword information in addition to the correspondence setting information for each of the importance levels. The keyword setting information according to the present embodiment has a similar data structure to that of the keyword information transmitted from the keyword analysis unit 1402 and is constituted by 24 bits including disaster keyword setting information, region keyword setting information, and time keyword setting information, which all have 8 bits. An item of each bit of the keyword setting information corresponds to the item of each bit of the keyword information. The keyword setting information is stored in the correspondence operation storage unit 509 while, for example, an address “0100-0000 h” is set as the leading address. The leading address of the address where the correspondence setting information of the importance level 0, 1, 2, or 3 is stored is similar to that of the first embodiment (see FIG. 4C).

In the keyword setting information, for example, “1” is set for the keyword with which the MFP 100 is desired to be operated at the time of the reception of the disaster prevention information, “0” is set for the keyword in a case where the operation is unnecessary. For example, with regard to the type of the disaster, in a case where the MFP 100 is operated when the disaster prevention information on the earth quake and the tidal wave is received, the disaster keyword setting information is set as “11000000”. With regard to the region, in a case where the MFP 100 is operated when the disaster prevention information on the southern part of Chiba prefecture and the northern part of Chiba prefecture is received, the region keyword setting information is set as “00001100”. With regard to the time, in a case where the MFP 100 is operated when the disaster prevention information including keywords of right now, seconds later, minutes later, hours later is received, the time keyword setting information is set as “11110000”.

The correspondence setting information for each of the importance levels is used in the MFP control unit 501 on the basis of the header information. It should be noted however that the MFP control unit 501 performs the processing in a case where the keyword information obtained from the keyword analysis unit 1402 includes the keyword with which the MFP 100 is desired to be operated. The MFP control unit 501 determines whether or not the keyword information includes the keyword with which the MFP 100 is desired to be operated by comparing the keyword information with the keyword setting information.

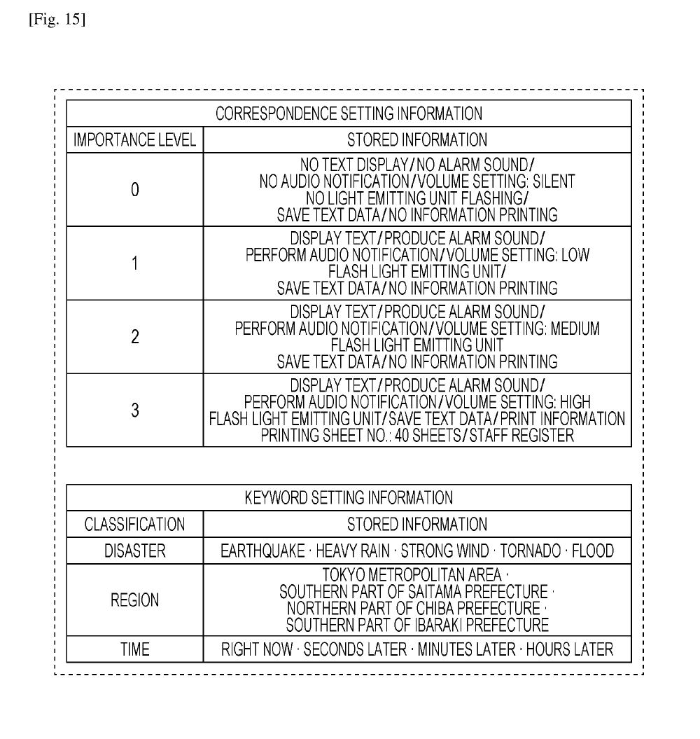

FIGS. 13A to 13C are illustrative diagrams of a setting screen displayed on the display unit 401 of the UI unit 206 at the time of the setting of the keyword setting information.

FIG. 13A illustrates a screen for performing a setting of the disaster keyword setting information. The user selects the keyword for operating the MFP 100 from the displayed keywords in a case where the keyword is included in the text part of the disaster prevention information. The bit relevant to the disaster keyword setting information is set as “1” in accordance with the selection result of the user. When the “next” button is pressed, the screen is shifted to the setting screen for the other keyword setting information.

FIG. 13B illustrates a screen for performing a setting of the region keyword setting information. The user selects the keyword for operating the MFP 100 from the displays keywords in a case where the keyword is included in the text part of the disaster prevention information. The bit relevant to the region keyword setting information is set as “1” in accordance with the selection result of the user. When the “next” button is pressed, the screen is shifted to the setting screen for the other keyword setting information.

FIG. 13C illustrates a screen for performing a setting of the time keyword setting information. The user selects the keyword for operating the MFP 100 from the displays keywords in a case where the keyword is included in the text part of the disaster prevention information. The bit relevant to the time keyword setting information is set as “1” in accordance with the selection result of the user. When the “next” button is pressed, the setting of the other keyword setting information is ended, and the screen is shifted to the selection screen of the importance level as illustrated in FIG. 5C, for example. Each of the keyword setting information set by each of the screens of FIGS. 13A to 13C is stored in the keyword storage unit 1401.

FIG. 14 is a flow chart illustrating the setting processing of the keyword setting information and the correspondence setting information. This processing is processing obtained by adding the setting processing of the keyword setting information to the setting processing of the correspondence setting information illustrated in FIG. 8A. Since the processing in S1701 to S1704 is similar to the processing in S1101 to S1104 of FIG. 8A, descriptions thereof will be omitted.

When it is determined that the “disaster prevention setting” button 702 on the setting change screen is pressed to select the disaster prevention setting (S1704: Y), the MFP control unit 501 displays the disaster prevention setting screen of FIG. 13A on the display unit 401. When the user selects the keyword from the disaster prevention setting screen, the MFP control unit 501 sets the disaster keyword setting information (S1705). When the “next” button is pressed after the user selects the keyword from the disaster prevention setting screen, the MFP control unit 501 displays a region setting screen of FIG. 13B on the display unit 401.

When the user selects the keyword from the region setting screen, the MFP control unit 501 sets the region keyword setting information (S1706). When the “next” button is pressed after the user selects the keyword from the region setting screen, the MFP control unit 501 displays a time setting screen of FIG. 13C on the display unit 401.

When the user selects the keyword from the time setting screen, the MFP control unit 501 sets the time keyword setting information (S1707). When the “next” button is pressed after the user selects the keyword from the disaster prevention setting screen, the MFP control unit 501 displays the importance level selection screen of FIG. 5C on the display unit 401.

According to the present embodiment, the MFP control unit 501 sets the bit relevant to the selected keyword as “1” and the bit relevant to the keyword that is not selected as “0” in the processing in S1705 to S1707. Since the processing in S1708 to S1117 is similar to the processing in S1105 to S1114 of FIG. 8A, descriptions thereof will be omitted. With the above-described processing, the keyword setting information and the correspondence setting information are set to be stored in the correspondence operation storage unit 509. FIG. 15 is an illustrative diagram of the keyword setting information and the correspondence setting information.

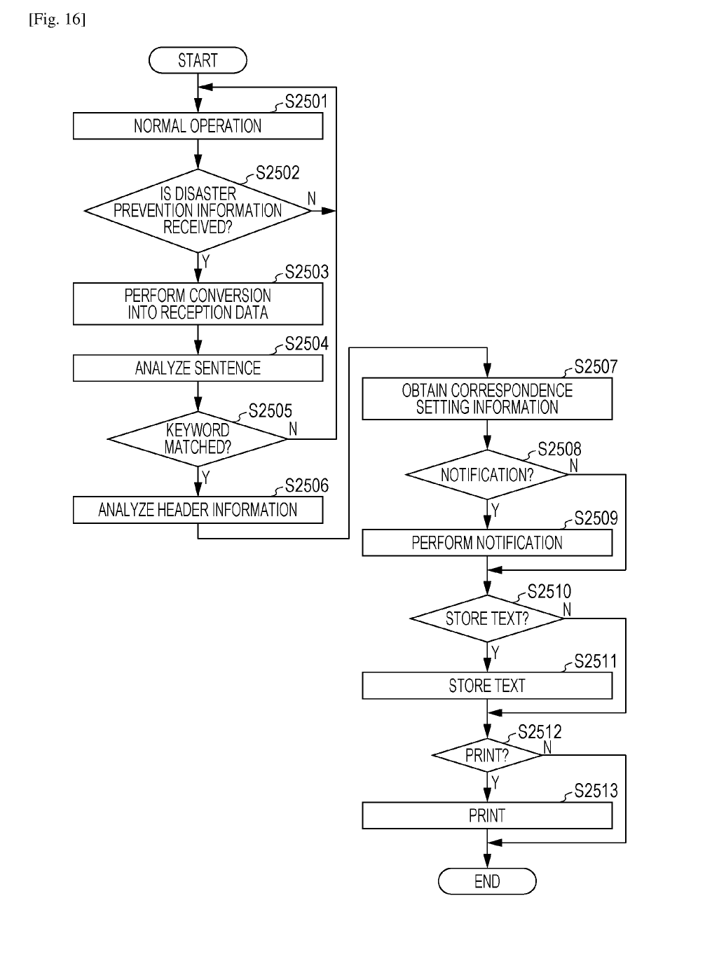

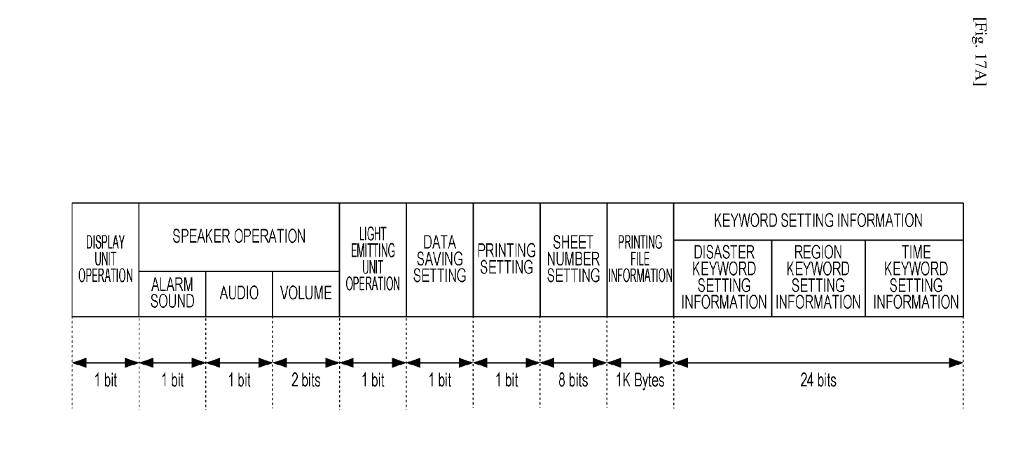

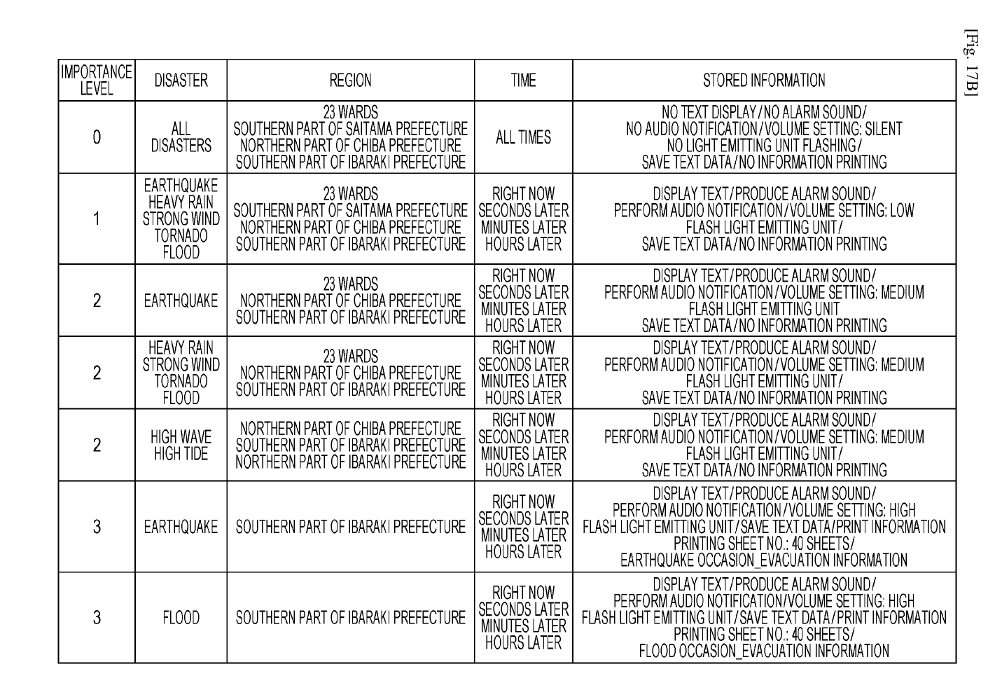

FIG. 16 is a flow chart illustrating the notification processing of the disaster prevention information by the MFP 100 according to the second embodiment. This processing is processing obtained by adding an analysis processing of the keyword to the notification processing of the disaster prevention information according to the first embodiment illustrated in FIG. 9. Since the processing in S2501 to S2503 is similar to the processing in S2401 to S2403 of FIG. 9, descriptions thereof will be omitted.

The keyword analysis unit 1402 obtains the reception data and analyzes the sentence of the text part (S2504). The keyword analysis unit 1402 compares the reception data with the keyword previously stored in the keyword storage unit 1401 and generates the keyword information representing the matched keyword. The keyword analysis unit 1402 inputs the generated keyword information to the MFP control unit 501.

The MFP control unit 501 compares the keyword information obtained from the keyword analysis unit 1402 with the keyword setting information stored in the correspondence operation storage unit 509 and determines whether or not the matched keyword exists (S2505). Accordingly, it is determined whether or not the disaster prevention information includes the keyword set by the user. In a case where the matched keyword does not exist (S2505: N), the MFP control unit 501 determines that the disaster prevention information does not include the keyword set by the user, and the MFP control unit 501 puts the MFP 100 in the state of the normal operation. In a case where the matched keyword exists (S2505: Y) the MFP control unit 501 determines that the disaster prevention information includes the keyword set by the user and performs the processing in S2506 and subsequent steps. Since the processing in S2506 and subsequent steps is similar to the processing in S2404 and subsequent steps of FIG. 9, descriptions thereof will be omitted.

As described above, at the time of the reception of the disaster prevention information, the MFP 100 determines the importance level of the disaster prevention information and the keyword included in the sentence of the disaster prevention information and performs the notification of the disaster prevention information in the notification mode in accordance with the determination result of the keyword and the importance level. According to the present embodiment, when the keyword set by the user is included in the disaster prevention information, the MFP 100 performs the notification of the disaster prevention information, and when the keyword is not included in the disaster prevention information, the MFP 100 does not perform the notification. For this reason, it is possible to perform the notification of the disaster prevention information in the notification mode desired by the user.

### Third Embodiment

The MFP 100 may change the notification mode of the disaster prevention information depending on the type of the disaster, the region information, or the time information even in the case of the same importance level. In this case, similarly as in the first and second embodiments, the MFP 100 performs the notification of the disaster prevention information or saving of the sentence of the text part in accordance with the importance level included in the disaster prevention information, but the content of the correspondence setting information for this purpose is varied.

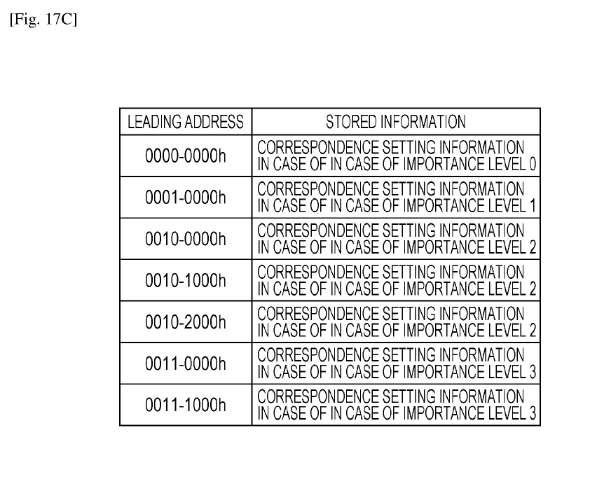

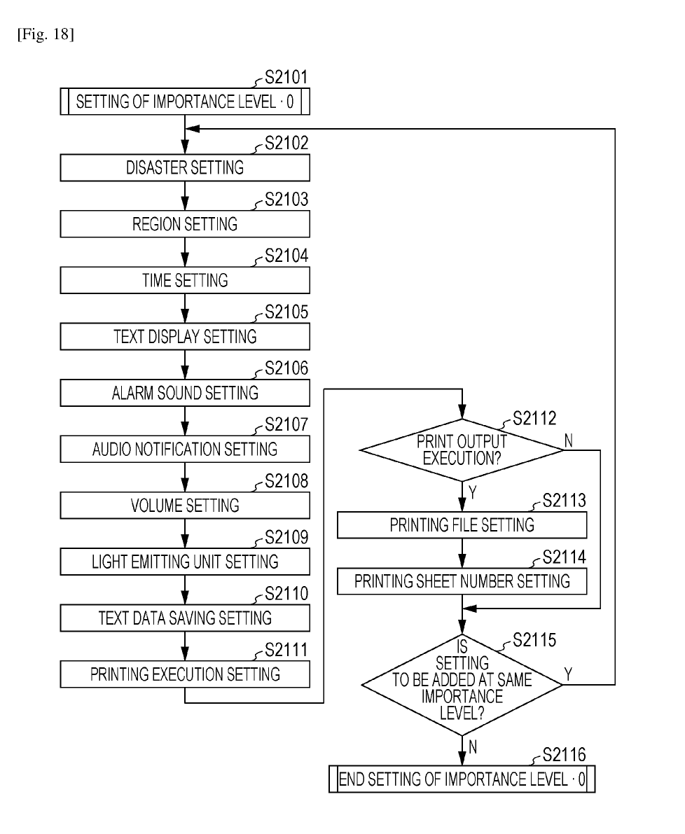

The disaster prevention radio system according to a third embodiment has a similar configuration to that of the disaster prevention radio system according to the second embodiment, and therefore descriptions of the configuration will be omitted. The third embodiment is different from the second embodiment in the correspondence setting information stored in the correspondence operation storage unit 509. FIGS. 17A to 17C are explanatory diagrams for describing the correspondence setting information according to the third embodiment.

The correspondence operation storage unit 509 stores the correspondence setting information having the data structure exemplified in FIG. 17A. This correspondence setting information is obtained by combining the correspondence setting information of FIG. 4B described in the first embodiment with the keyword setting information described in the second embodiment. The MFP control unit 501 obtains the correspondence setting information of FIG. 4B and the keyword setting information by processing similar to the second embodiment and generates the correspondence setting information having the data structure of FIG. 17A by combining the correspondence setting information with the keyword setting information. This correspondence setting information is stored for each of the importance levels. In addition, plural pieces of correspondence setting information can be set depending on the keyword setting information even in the case of the same importance level. FIG. 17B is an illustrative diagram of the correspondence setting information for each of the importance levels and each keyword information. In FIG. 17B, plural pieces of correspondence setting information are set in accordance with the keyword information for the importance level 2 and the importance level 3.

The correspondence operation storage unit 509 that stores the correspondence setting information having the above-described configuration is constituted by a storage device such as a memory. FIG. 17C is an illustrative diagram of the leading address of the correspondence setting information stored in the correspondence operation storage unit 509. In an example of FIG. 17C, while an address “0000-0000 h” of the correspondence operation storage unit 509 is set as a leading address, the correspondence setting information in the case of the importance level 0 is stored. While an address “0001-0000 h” of the correspondence operation storage unit 509 is set as a leading address, the correspondence setting information in the case of the importance level 1 is stored. While an address “0010-0000 h” of the correspondence operation storage unit 509 is set as a leading address, the correspondence setting information in the case of the importance level 2 is stored. While an address “0011-0000 h” of the correspondence operation storage unit 509 is set as a leading address, the correspondence setting information in the case of the importance level 3 is stored.

In a case where plural pieces of correspondence setting information are stored for the same importance level, 16th to 19th bits of the address are used. For example, in a case where the plural pieces of correspondence setting information are stored in accordance with the disaster information, the region information, or the like with regard to the correspondence setting information of the “importance level 2”, the correspondence setting information related to the earth quake is stored in an address “0010-0000 h” of the correspondence operation storage unit 509. In addition, the correspondence setting information related to the heavy rain or the strong wind is stored in an address “0010-1000 h” of the correspondence operation storage unit 509. The correspondence setting information related to the high wave or the high tide is stored in an address “0010-2000 h” of the correspondence operation storage unit 509.

At the time of the reception of the disaster prevention information, the MFP control unit 501 obtains the header information from the header analysis unit 508 and the keyword information from the keyword analysis unit 1402. In a case where the obtained header information is “00”, the MFP control unit 501 determines that the disaster prevention information is the “importance level 0” and performs pattern matching between the keyword setting information set in the correspondence setting information where the address “0000-0000 h” is set as the leading address and the obtained keyword information. In a case where the keyword is matched, the MFP control unit 501 controls the respective units in the operation of the MFP 100 on the basis of the correspondence setting information and performs the notification of the disaster prevention information in the notification mode in accordance with the correspondence setting information. In a case where the plural pieces of correspondence setting information are set, the MFP control unit 501 performs the pattern matching for each correspondence setting information and controls the respective units in the operation of the MFP 100.

In a case where the obtained header information is “01”, the MFP control unit 501 determines that the disaster prevention information is the “importance level 1” and performs the similar processing. In a case where the obtained header information is “10”, the MFP control unit 501 determines that the disaster prevention information is the “importance level 2” and performs the similar processing. In a case where the obtained header information is “11”, the MFP control unit 501 determines that the disaster prevention information is the “importance level 3” and performs the similar processing.

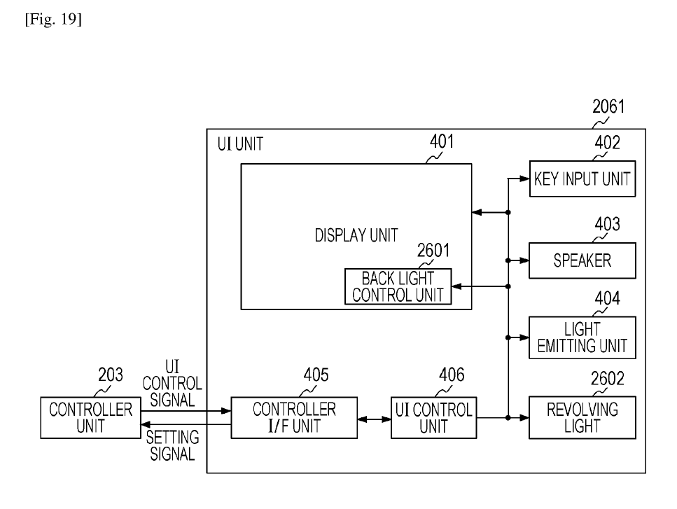

The setting processing of the correspondence setting information described above is performed by the processing similar to FIG. 8A, but the setting processing for each of the importance levels illustrated in FIG. 8B is varied since the item included in the correspondence setting information is varied. FIG. 18 is a flow chart illustrating the setting processing of the correspondence setting information for each of the importance levels according to the third embodiment. Here, descriptions will be given while an example in which the importance level is “0” is used, but the similar processing is also performed when the correspondence setting information of the other importance level is set.

When the user selects the “importance level●0” (S1106 of FIG. 8A: the importance level 0), the MFP control unit 501 displays the disaster prevention setting screen of FIG. 13A on the display unit 401 of the UI unit 206. When the user selects the keyword from the disaster prevention setting screen, the MFP control unit 501 sets the disaster keyword setting information (S2102). When the “next” button is pressed after the user selects the keyword from the disaster prevention setting screen, the MFP control unit 501 displays the region setting screen of FIG. 13B on the display unit 401.

When the user selects the keyword from the region setting screen, the MFP control unit 501 sets the region keyword setting information (S2103). When the “next” button is pressed after the user selects the keyword from the region setting screen, the MFP control unit 501 displays the time setting screen of FIG. 13C on the display unit 401.

When the user selects the keyword from the time setting screen, the MFP control unit 501 sets the time keyword setting information (S2104). When the “next” button is pressed after the user selects the keyword from the disaster prevention setting screen, the MFP control unit 501 displays the text display setting screen of FIG. 6A on the display unit 401.

According to the present embodiment, the MFP control unit 501 sets the bit relevant to the selected keyword as “1” and the bit relevant to the keyword that is not selected as “0” by the processing in S2102 to S2104.

Since the processing in S2105 to S2114 after the text display setting screen is displayed is similar to the processing in S1202 to S1211 of FIG. 8B, descriptions thereof will be omitted. After the printing sheet number is set in the processing in S2114 or after it is determined that the print output is not performed by the processing in S2112, the MFP control unit 501 displays a screen on the display unit 401 for selecting whether or not the correspondence setting information is set at the same importance level (S2115). In a case where the user performs an input indicating that the correspondence setting information is set at the same importance level in accordance with this screen (S2115: Y), the MFP control unit 501 returns to the processing in S2102 and continuously performs the setting processing of the correspondence setting information at the same importance level. In a case where the user performs an input indicating that the correspondence setting information is not set at the same importance level (S2115: N), the MFP control unit 501 ends the processing in S1107 (see FIG. 8A).

While the above-described processing is repeatedly performed, the correspondence setting information for each of the importance levels and each of the keywords as illustrated in FIG. 17C is set. The notification processing of the disaster prevention information is similarly performed as in the first and second embodiments. For this reason, the MFP 100 can perform the notification of the disaster prevention information in the notification mode desired by the user in accordance with the importance level of the disaster prevention information and the sentence included in the disaster prevention information.

### Fourth Embodiment

While the UI unit 206 is provided with a revolving light like a light on a police car, the MFP 100 can provide a strong alarm to the user when disaster prevention information for notification of a disaster at a severe disaster level is received, for example. In addition, when a color of back light of a liquid crystal display is changed other than the revolving light, the notification of the disaster prevention information may be performed in the notification mode in accordance with the importance level. The MFP 100 according to a fourth embodiment is provided with a configuration for realizing the above-described notification mode.

Since the disaster prevention radio system according to the fourth embodiment has a configuration similar to the disaster prevention radio system according to the first embodiment, descriptions thereof will be omitted. The fourth embodiment is different from the first to third embodiments in the configuration of the UI unit included in the MFP 100. The configuration of the UI unit will be described, and descriptions of the other configuration similar to the other embodiments will be omitted.

FIG. 19 is a schematic diagram of the UI unit according to the fourth embodiment. A UI unit 2061 of FIG. 19 has a configuration obtained by adding a revolving light 2602 to the configuration of the UI unit 206 of FIG. 3A. In addition, the display unit 401 is a display provided with back light and includes a back light control unit 2601 configured to control an operation of the back light. Descriptions will be omitted on a similar configuration to the UI unit 206 of FIG. 3A.

The back light control unit 2601 changes the color of the back light of the display unit 401 under the control of the controller unit 203 via the UI control unit 406. With regard to the back light of the display unit 401, for example, the display unit 401 emits light in blue, orange, or red other than white at the time of a normal use. The back light control unit 2601 causes the back light to emit light in one of the above-described colors in accordance with an instruction of the controller unit 203. It should be noted that the back light may be emitted in colors other than the above-described colors.

The revolving light 2602 emits light and revolves under the control of the controller unit 203 via the UI control unit 406. The revolving light 2602 can emit light in a plurality of colors. One of the colors including blue, orange, and red, for example, is selected, and the revolving light 2602 emits light in the selected color. It should be noted that the revolving light 2602 may emit light in colors other than the above-described colors.

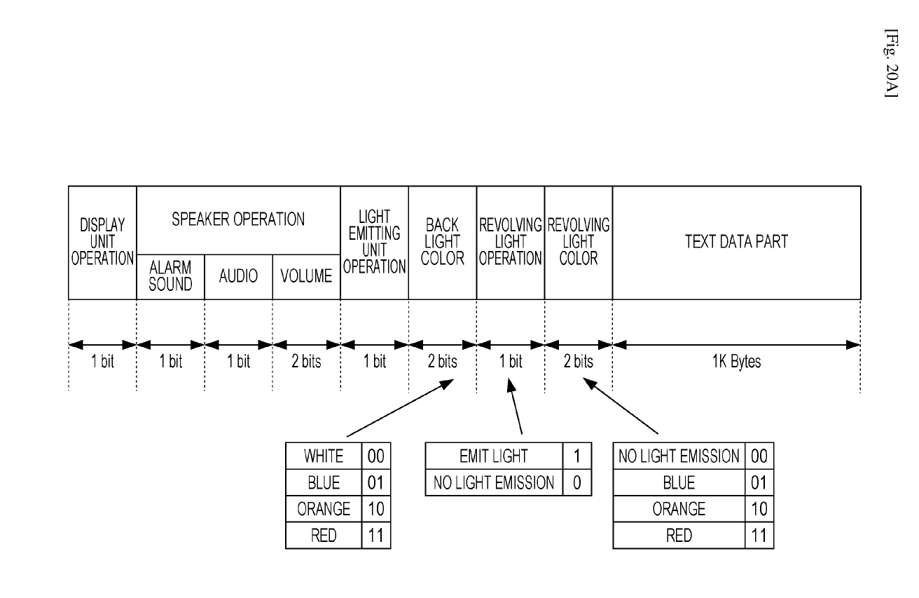

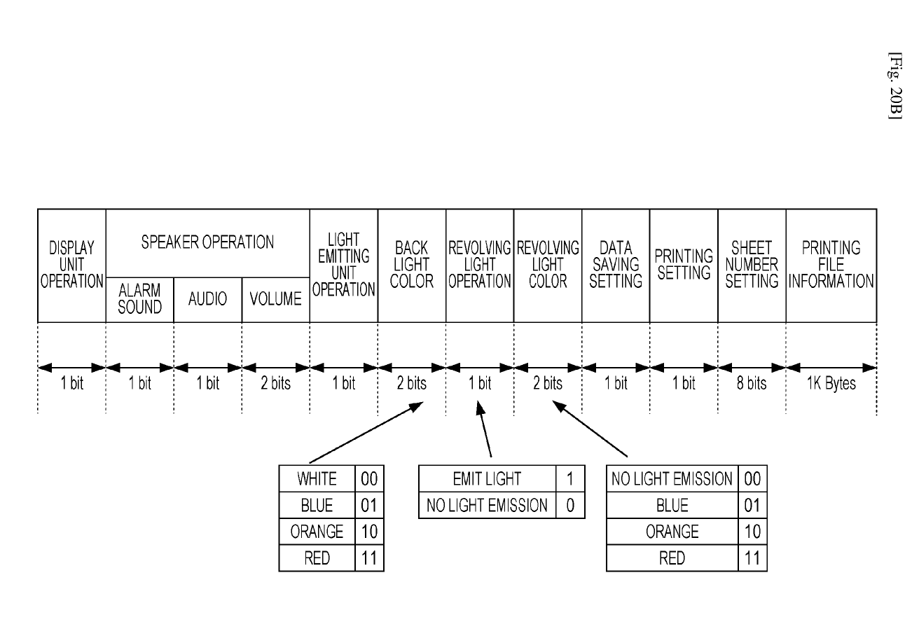

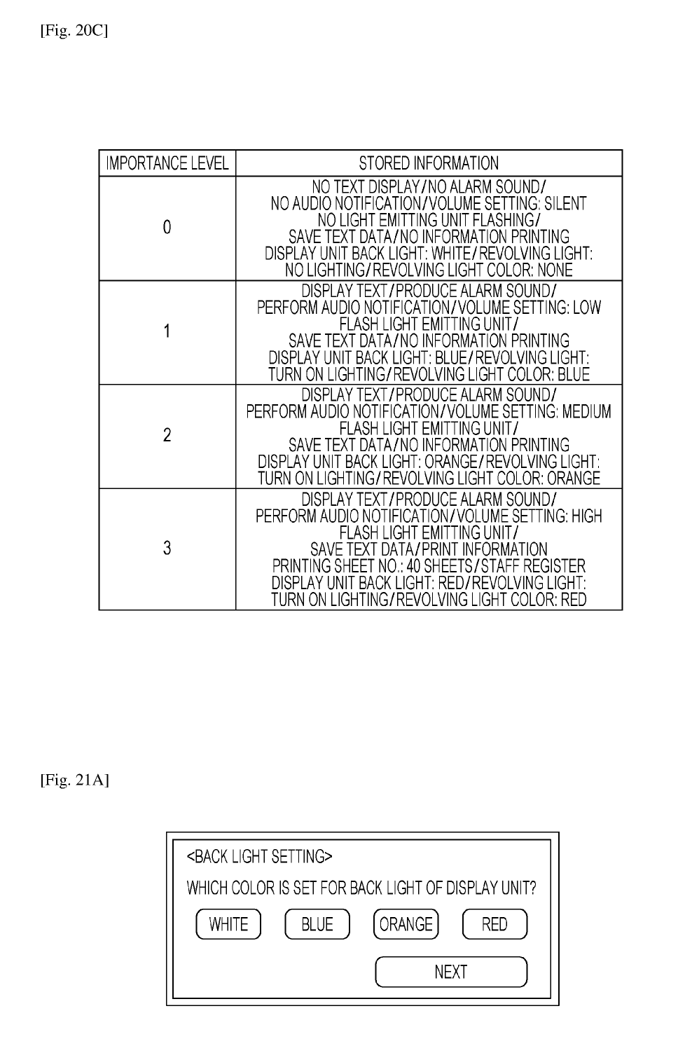

The controller unit 203 controls the operation of the UI unit 2061 by the UI control signal. The controller unit 203 stores the correspondence setting information for generating the UI control signal in the correspondence operation storage unit 509. FIGS. 20A to 20C are explanatory diagrams for describing the UI control signal and the correspondence setting information.

FIG. 20A exemplifies a configuration of the UI control signal. This UI control signal has a configuration obtained by adding a “back light color”, a “revolving light operation”, and a “revolving light color” to the UI control signal according to the first embodiment illustrated in FIG. 4A. The other items of the UI control signal are similar to those of FIG. 4A, and therefore descriptions thereof will be omitted.

In the “back light color”, a setting of the color of the back light of the display unit 401 is performed. The “back light color” is represented by 2-bit data. For example, the “back light color” indicates “white” at the time of the normal operation in the case of “00”, “blue” in the case of “01”, “orange” in the case of “10”, and “red” in the case of “11”

In the “revolving light operation”, a setting is performed on whether or not the revolving light 2602 is caused to emit light. The “revolving light operation” is represented by 1-bit data. For example, the “revolving light operation” indicates “no light emission” in the case of “0” and “emit light” in the case of “1”.

In the “revolving light color”, a setting of the light emission color of the revolving light 2602 is performed. The “revolving light color” is represented by 2-bit data. For example, the “revolving light color” indicates “no light emission” in the case of “00”, “blue” in the case of “01”, “orange” in the case of “10”, and “red” in the case of “11”.

FIG. 20B exemplifies a configuration of the correspondence setting information. This correspondence setting information has a configuration obtained by adding the “back light color”, the “revolving light operation”, and the “revolving light color” to the correspondence setting information according to the first embodiment illustrated in FIG. 4B. The other items of the correspondence setting information are similar to those of FIG. 4B, and therefore descriptions thereof will be omitted. The correspondence setting information according to the fourth embodiment is also stored for each of the importance levels in the correspondence operation storage unit 509 similarly as in the correspondence setting information according to the other embodiments.

The “back light color”, the “revolving light operation”, and the “revolving light color” of the correspondence setting information respectively have data configurations similar to the “back light color”, the “revolving light operation”, and the “revolving light color” of the UI control signal. FIG. 20C is an illustrative diagram of the correspondence setting information corresponding to each of the importance levels. The correspondence setting information is stored in the correspondence operation storage unit 509 at the address illustrated in FIG. 4C, for example.

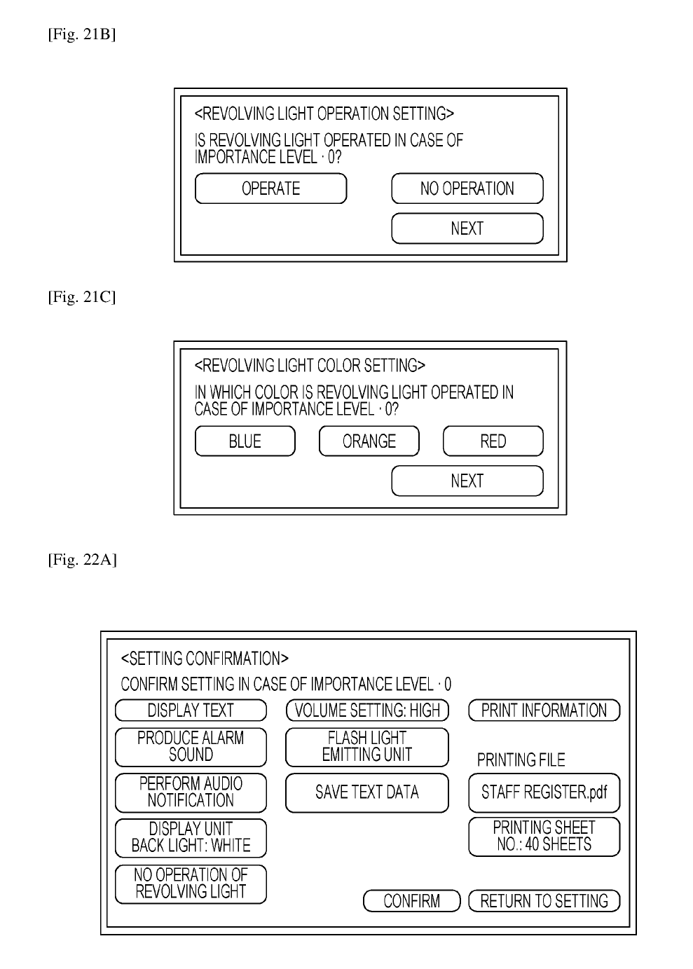

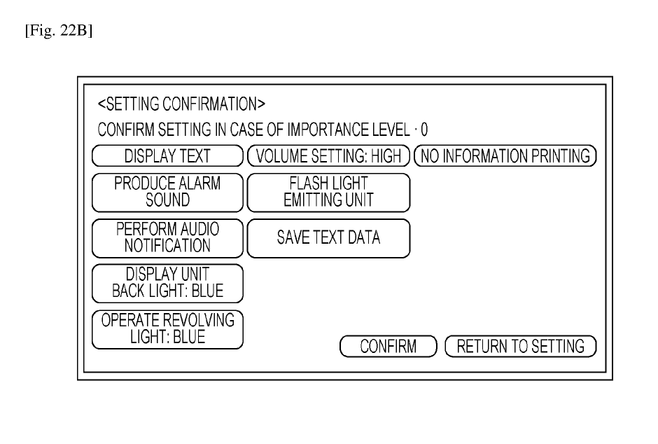

FIGS. 21A to 21C and FIGS. 22A and 22B are illustrative diagrams of a setting screen displayed on the display unit 401 of the UI unit 206 at the time of the setting of the correspondence setting information.

FIG. 21A illustrates a screen for performing a setting of the back light color. The user selects one of the displayed colors. In FIG. 21A, “white”, “blue”, “orange”, and “red” are the colors that can be selected. As a specific setting example, the back light color can be set to have a color with which the user more seriously recognizes the danger as the importance level is higher in a manner that “white” is set when the importance level is “0”, “blue” is set when the importance level is “1”, “orange” is set when the importance level is “2”, and “red” is set when the importance level is “3”.

In a case where “white” is selected, “00” is set in the “back light color” of the correspondence setting information. In a case where “blue” is selected, “01” is set in the “back light color” of the correspondence setting information. In a case where “orange” is selected, “10” is set in the “back light color” of the correspondence setting information. In a case where “red” is selected, “11” is set in the “back light color” of the correspondence setting information. When the “next” button is pressed, the screen is shifted to the setting screen for the next item of the correspondence setting information.

FIG. 21B illustrates a screen for performing an operation setting of the revolving light 2602. The user selects either “operate” or “no operation”. In a case where “operate” is selected, “1” is set in the “revolving light operation” of the correspondence setting information. In a case where “no operation” is selected, “0” is set in the “revolving light operation” of the correspondence setting information. When the “next” button is pressed, the screen is shifted.

FIG. 21C illustrates a screen for performing a setting of the color of the revolving light 2602. The screen of FIG. 21C is displayed when the “next” button is pressed after “operate” is selected in FIG. 21A. The user selects one of the displayed colors. In FIG. 21C, “blue”, “orange”, and “red” are the colors that can be selected. As a specific setting example, the color of the revolving light 2602 can be set to have a color with which the user more seriously recognizes the danger as the importance level is higher in a manner that “blue” is set when the importance level is “1”, “orange” is set when the importance level is “2”, and “red” is set when the importance level is “3”.

In a case where “white” is selected, “00” is set in the “revolving light color” of the correspondence setting information. In a case where “blue” is selected, “01” is set in the “revolving light color” of the correspondence setting information. In a case where “orange” is selected, “10” is set in the “revolving light color” of the correspondence setting information. In a case where “red” is selected, “11” is set in the “revolving light color” of the correspondence setting information. When the “next” button is pressed, the screen is shifted.

FIG. 22A illustrates a screen for confirming the correspondence setting information in a case where the revolving light 2602 is not operated. The screen of FIG. 22A is displayed when the “next” button is pressed after “no operation” is selected in FIG. 21B. The user confirms the setting content by using this screen. When the setting content is correct, the user selects “confirm”, and when the setting content is incorrect, the user performs the setting again. In a case where the user performs the setting again, the user presses a “return to setting” button. When the “return to setting” button is pressed, the screen is shifted to the setting screen of FIG. 6A. In a case where the “confirm” button is selected, the correspondence setting information having this content is stored in the correspondence operation storage unit 509.

FIG. 22B illustrates a screen for confirming the correspondence setting information in a case where the revolving light 2602 is operated. The screen of FIG. 22B is displayed when the “next” button is pressed in FIG. 21C. The user confirms the setting content by using this screen. When the setting content is correct, the user selects “confirm”, and when the setting content is incorrect, the user performs the setting again. In a case where the user performs the setting again, the user presses a “return to setting” button. When the “return to setting” button is pressed, the screen is shifted to the setting screen of FIG. 6A. In a case where the “confirm” button is selected, the correspondence setting information having this content is stored in the correspondence operation storage unit 509.

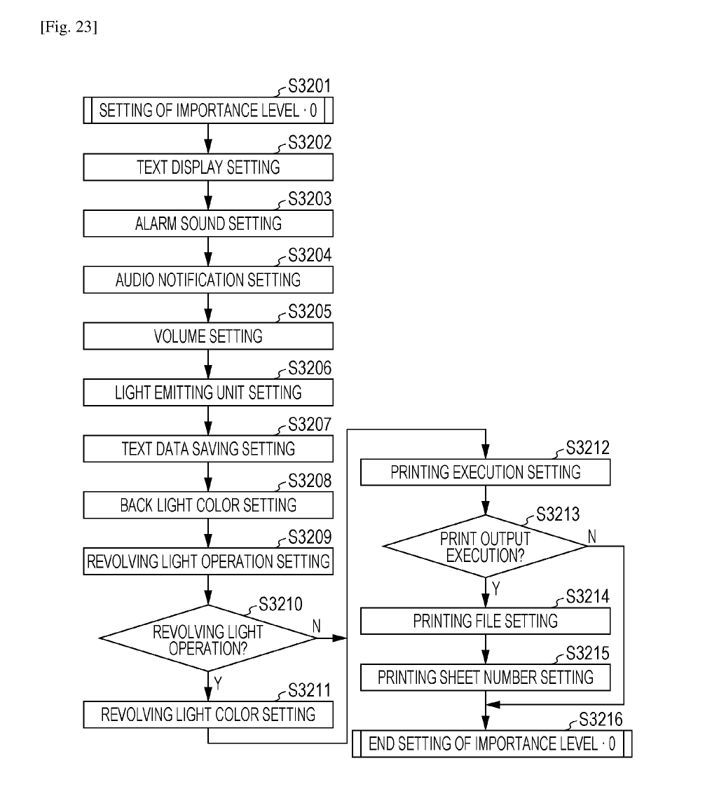

The above-described setting processing of the correspondence setting information is performed by the processing similar to FIG. 8A, but the setting processing for each of the importance levels illustrated in FIG. 8B is varied since the item included in the correspondence setting information is varied. FIG. 23 is a flow chart illustrating the setting processing of the correspondence setting information for each of the importance levels according to the fourth embodiment. Here, an example in which the importance level is “0” will be described, but the similar processing is also performed when the correspondence setting information having the other importance level is set.

When the user selects the “importance level●0” (S1106 of FIG. 8A: the importance level 0), the MFP control unit 501 performs processing in S3202 to S3207 similar to the processing in S1202 to S1207 of FIG. 8B. Descriptions of the processing in S1202 to S1207 will be omitted. After the setting of the “data saving setting” of the correspondence setting information is ended by the processing in S3207, when the “next” button on the text data saving setting screen is pressed, a back light setting screen of FIG. 21A is displayed on on the display unit 401. While the user selects a color from the back light setting screen, the MFP control unit 501 sets the “back light color” of the correspondence setting information (S3208). Here, the user selects “white” to set the correspondence setting information at the importance level 0. When the “next” button is pressed after the user selects the color from the back light setting screen, the MFP control unit 501 displays a revolving light operation setting screen of FIG. 21B on the display unit 401.

While the user selects either “operate” or “no operation” from the revolving light operation setting screen, the MFP control unit 501 selects the “revolving light operation” of the correspondence setting information (S3209). In a case where the “next” button is pressed after “operate” is selected (S3210: Y), the MFP control unit 501 displays a revolving light color setting screen of FIG. 21C on the display unit 401. While the user selects a color from the revolving light color setting screen, the MFP control unit 501 sets the “revolving light color” of the correspondence setting information (S3211). When the “next” button is pressed after the user selects the color from the revolving light color setting screen, the MFP control unit 501 displays the printing execution setting screen of FIG. 6G on the display unit 401. In a case where the “next” button is pressed after the MFP control unit 501 selects “no operation” from the revolving light operation setting screen too (S3210: N), the printing execution setting screen of FIG. 6G is displayed on the display unit 401. Here, the user selects “no operation” from the revolving light operation setting screen to set the correspondence setting information at the importance level 0.

Since the processing in S3212 and subsequent steps which is performed after the printing execution setting screen is displayed is similar to the processing in S1208 and subsequent steps of FIG. 8B, descriptions thereof will be omitted. With the above-described processing, the MFP control unit 501 ends the processing in S1107 (see FIG. 8A).

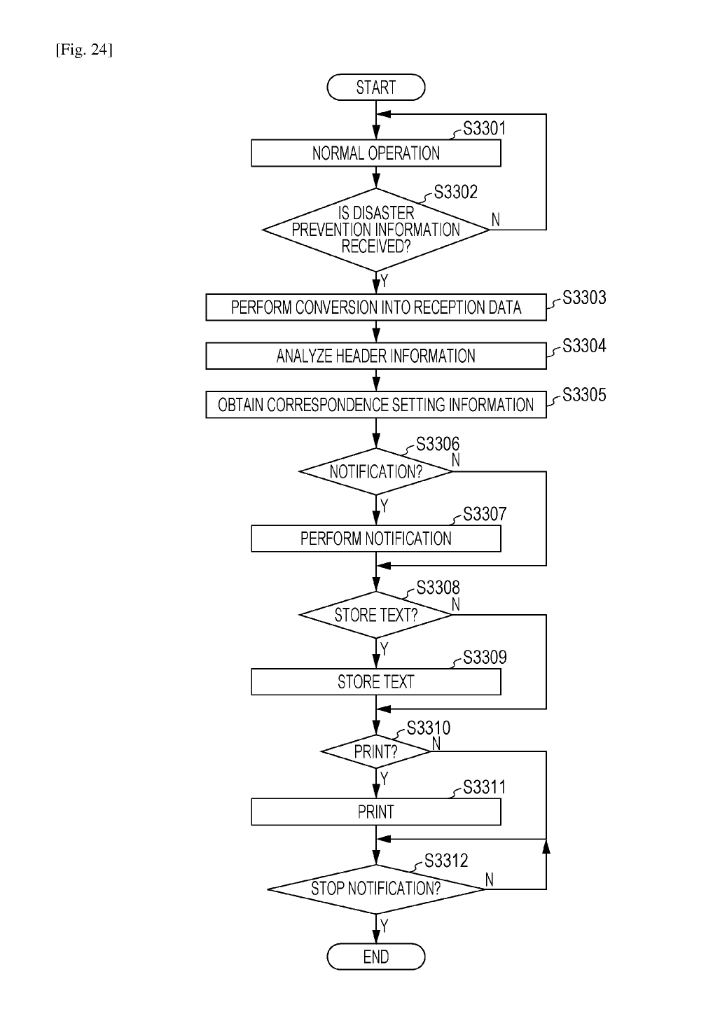

FIG. 24 is a flow chart illustrating the notification processing of the disaster prevention information by the MFP 100 according to the fourth embodiment. This processing is processing obtained by adding an instruction of notification stop to the notification processing of the disaster prevention information according to the first embodiment illustrated in FIG. 9. The instruction of the notification stop is input by the user using the UI unit 206.

The processing in S3301 to S3311 is similar to the processing in S2401 to S2411 of FIG. 9. It should be noted however that, in the processing in S3307, the MFP control unit 501 performs the notification of the disaster prevention information in accordance with the content of the correspondence setting information by way of a change of the back light color and the light emission in a predetermined color of the revolving light 2602 in addition to the display of the sentence by the display unit 401, the output of the audio by the speaker 403, and the like.

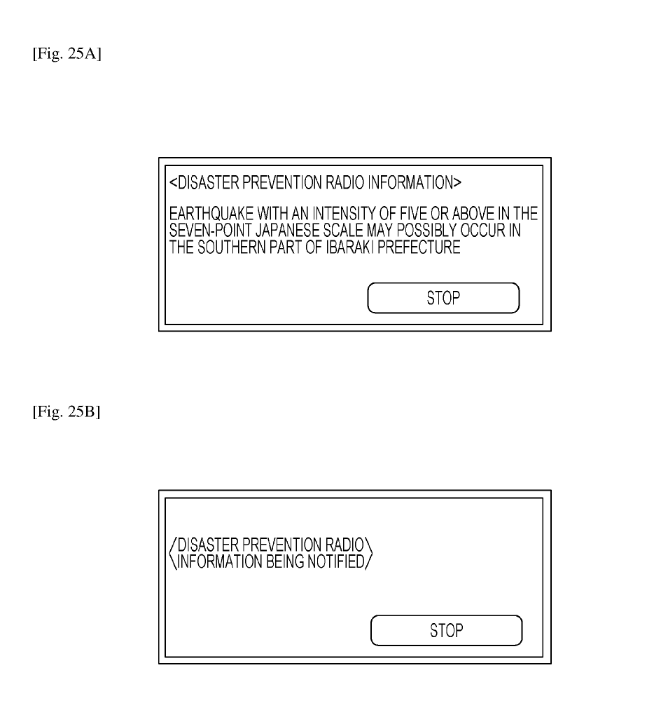

After the print output is ended (S3311) or in a case where the print output is not performed (S3310: N), the MFP control unit 501 displays a screen for inputting the instruction of the notification stop on the display unit 401. FIGS. 25A and 25B are illustrative diagrams of the screen for inputting the instruction of the notification stop. FIG. 25A illustrates a screen displayed when the disaster prevention information having a high importance level is notified. FIG. 25B illustrates a screen displayed when the disaster prevention information having a low importance level is notified. When the user presses a “stop” button on either screen, the instruction for stopping the notification of the disaster prevention information is input to the MFP control unit 501.

The MFP control unit 501 inputs a UI control signal for stopping the notification to the UI unit 206 in accordance with the instruction for stopping the notification of the disaster prevention information input from the UI unit 206. The UI unit 206 ends the notification using the back light, the speaker 403, the light emitting unit 404, and the revolving light 2602 in accordance with this UI control signal (S3312: Y). The MFP control unit 501 that has ended the notification puts the MFP 100 in the normal state.

According to the present embodiment, until the user presses the “stop” button and the instruction for stopping the notification of the disaster prevention information is input to the notification of the disaster prevention information is input to the MFP control unit 501, the notification of the disaster prevention information is continuously performed. It should be noted that, without performing the display of the screen exemplified in FIGS. 25A and 25B, when the user repeatedly performs touching of the display unit 401, for example, the UI unit 206 may input the instruction for stopping the notification of the disaster prevention information to the MFP control unit 501. In addition, the stop instruction may be input by way of a key input using the key input unit 402.

As described above, at the time of the reception of the disaster prevention information, the MFP 100 performs the notification of the disaster prevention information in the notification mode in accordance with the importance level of the disaster prevention information. The change of the color of the back light and the revolving light 2602 in addition to the display on the display unit 401, the sound output from the speaker 403, the light flashing by the light emitting unit 404, the print output of the image associated with the disaster prevention information, and the saving of the text of the disaster prevention information can be used for the notification mode. For this reason, the MFP 100 can provide a strong alarm to the user. In addition, the MFP 100 can stop the notification on the basis of the determination by the user. It should be noted that the MFP 100 may have a configuration obtained by combining the configurations according to the first to fourth embodiments to one another.

As described above, according to the above-described respective embodiments, while the notification of the disaster prevention information is performed in the notification mode in accordance with the importance level, the disaster prevention information can be appropriately transmitted to the user.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-173231, filed Sep. 2, 2015, which is hereby incorporated by reference herein in its entirety.

1. An image forming apparatus comprising:
a reception unit configured to receive disaster prevention information including information indicating an importance level of a content;
a printing unit configured to print and output an image on a predetermined sheet;
a notification unit configured to perform notification of the disaster prevention information; and
a control unit configured to recognize the importance level of the disaster prevention information and cause the notification unit to perform the notification of the disaster prevention information in a notification mode in accordance with the recognized importance level and the printing unit to print and output a predetermined image in accordance with the importance level.

2. The image forming apparatus according to claim 1,
wherein, in a case where the disaster prevention information includes a predetermined keyword, the control unit causes the notification unit to perform the notification of the disaster prevention information in the notification mode in accordance with the importance level.

3. The image forming apparatus according to claim 1, further comprising:
a correspondence operation storage unit that stores correspondence setting information for setting a notification mode corresponding to a plurality of importance levels,
wherein the control unit refers to the correspondence setting information corresponding to the recognized importance level and causes the notification unit to perform the notification of the disaster prevention information in the notification mode set by the correspondence setting information.

4. The image forming apparatus according to claim 3,
wherein the correspondence operation storage unit stores the correspondence setting information corresponding to the importance level and a keyword included in the disaster prevention information, and
wherein the control unit refers to the correspondence setting information corresponding to the recognized importance level and the keyword included in the disaster prevention information and causes the notification unit to perform the notification of the disaster prevention information set by the correspondence setting information.

5. The image forming apparatus according to claim 3,
wherein the notification unit includes a display unit configured to display an image, a sound output unit configured to output sound, a light emitting unit configured to emit light, and a revolving light that can emit light in a plurality of colors, and
wherein the correspondence operation storage unit stores the correspondence setting information in which data is set which indicates whether or not a sentence representing a content of the disaster prevention information is displayed on the display unit, whether or not the sound is output from the sound output unit, whether or not the light emitting unit is caused to emit the light, whether or not the revolving light is caused to emit light and a color in a case where the revolving light is caused to emit the light, and whether or not the printing unit is caused to print and output the image.

6. The image forming apparatus according to claim 5,
wherein the correspondence operation storage unit stores the correspondence setting information in which data is set which indicate a volume of the sound output from the sound output unit and whether or not the sentence representing the content of the disaster prevention information is output by way of sound.

7. The image forming apparatus according to claim 3, further comprising:
a text data storage unit configured to store text data indicating a sentence representing a content of the disaster prevention information,
wherein the correspondence operation storage unit stores the correspondence setting information in which data is set which indicates whether or not the text data is stored, and wherein the control unit refers to the correspondence setting information corresponding to the recognized importance level, and in a case where the correspondence setting information indicates the setting to store the text data, the text data is stored in the text data storage unit.

8. The image forming apparatus according to claim 1,
wherein the control unit causes the notification unit to end the notification of the disaster prevention information when ending of the notification is instructed by a predetermined input unit.

9. The image forming apparatus according to claim 1, further comprising:
a disaster occasion image storage unit configured to store a disaster occasion image formed on the sheet in a time of disaster,
wherein the control unit causes the printing unit to print and output an image obtained by combining the disaster occasion image stored in the disaster occasion image storage unit with a sentence representing the content of the disaster prevention information.

10. A notification method executed by an apparatus including a reception unit configured to receive disaster prevention information including information indicating an importance level of a content, a printing unit configured to perform image formation on a predetermined sheet, and a notification unit configured to perform notification of the disaster prevention information, the notification method comprising:
recognizing the importance level of the disaster prevention information; and
causing the notification unit to perform the notification of the disaster prevention information in a notification mode in accordance with the recognized importance level and the printing unit to print and output a predetermined image in accordance with the importance level.

11. A computer-readable storage medium that stores a computer program for causing a computer including a reception unit configured to receive disaster prevention information including information indicating an importance level of a content, a printing unit configured to print and output an image on a predetermined sheet, and a notification unit configured to perform notification of the disaster prevention information, to function as a control unit configured to recognize the importance level of the disaster prevention information and cause the notification unit to perform the notification of the disaster prevention information in a notification mode in accordance with the recognized importance level and the printing unit to print and output a predetermined image in accordance with the importance level.
